(19) United States
(12) Patent Application Publication
(10) Pub. No.: US 2025/0083454 A1
(43) Pub. Date: Mar. 13, 2025

(54) EJECTION AMOUNT UPPER LIMIT VALUE DETERMINATION METHOD AND PRINTING DEVICE

(71) Applicant: SEIKO EPSON CORPORATION, Tokyo (JP)

(72) Inventor: Yoshio OKUMURA, Matsumoto (JP)

(21) Appl. No.: 18/826,369

(22) Filed: Sep. 6, 2024

(30) Foreign Application Priority Data
Sep. 8, 2023 (JP) 2023-145942

(51) Int. Cl. B41J 2/21; B41J 2/045; B41J 2/205

(52) U.S. Cl. CPC B41J 2/2132; B41J 2/04558; B41J 2/2121; B41J 2002/2058

(57) ABSTRACT

A method performs forming a test pattern on a medium, the test pattern including a plurality of patches having different ejection amounts per unit area, determining an ejection amount minimum value that is a minimum value of the allowable range and an ejection amount maximum value that is a maximum value of the allowable range based on an ejection amount reference value that is a reference of an allowable range of the upper limit value of the ejection amount, determining a provisional ejection amount upper limit value that is a provisional value of the upper limit value based on a reading result of at least a part of the plurality of patches, and the upper limit value is determined so as to be based on the ejection amount minimum value, the ejection amount maximum value, and the provisional ejection amount upper limit value.

The present application is based on, and claims priority from JP Application Serial Number 2023-145942, filed Sep. 8, 2023, the disclosure of which is hereby incorporated by reference herein in its entirety.

### BACKGROUND

### 1. Technical Field

The present disclosure relates to a technique for determining an upper limit value of an ejection amount per unit area of a liquid ejected from a print head onto a medium.

### 2. Related Art

As a printing device, an inkjet printer that ejects ink droplets from a plurality of nozzles of a print head onto a print medium is known. When the ejection amount of ink per unit area with respect to the printing medium is large, for example, phenomena such as “color saturation”, “overflow”, “bleeding”, and “aggregation” may occur. Here, “color saturation” is a phenomenon in which the coloring hardly changes even when the ink ejection amount increases and “overflow” is a phenomenon in which the peripheral portion becomes darker than the central portion in the process of the ink drying. “Bleeding” is a phenomenon in which ink bleeds out to the surroundings and “aggregation” is a phenomenon in which the dispersibility of ink dots is lowered. These phenomena may differ in degree depending on the type of printing medium and the type of ink. Therefore, an ink ejection amount upper limit value indicating an upper limit ink ejection amount at which these phenomena are suppressed is set and is used for creating a color conversion lookup table (LUT) or the like. The printing device disclosed in JP-A-2018-126993 performs the above described process for determining the ink ejection amount upper limit value.

### SUMMARY

The ejection amount upper limit value determination method of the present disclosure, an ejection amount upper limit value determination method for determining an upper limit value of an ejection amount per unit area of a liquid ejected from a print head to a medium, the method includes
a test pattern forming step for forming on the medium a test pattern including a plurality of patches having different ejection amounts;
an allowable range determination step for acquiring an ejection amount reference value, which is a reference of an allowable range of the upper limit value, and determining, based on the ejection amount reference value, an ejection amount minimum value, which is a minimum value of the allowable range, and an ejection amount maximum value, which is a maximum value of the allowable range;
a temporary determination step for acquiring a reading result of at least a part of the plurality of patches and, based on the reading result, determining a provisional ejection amount upper limit value, which is a provisional value of the upper limit value; and
a first final determination step for determining the upper limit value based on the ejection amount minimum value, the ejection amount maximum value, and the provisional ejection amount upper limit value such that the upper limit value is greater than or equal to the ejection amount minimum value and less than or equal to the ejection amount maximum value.

The printing device of the present disclosure includes
a print head configured to eject liquid onto the medium;
a control section configured to perform control to form a test pattern including a plurality of patches having different ejection amounts per unit area with respect to the liquid on the medium and configured to perform a process of determining an upper limit value of the ejection amount; and
a reading section configured to read at least a part of the plurality of patches, wherein
the control section performs
a first process for acquiring an ejection amount reference value, which is a reference of an allowable range of the upper limit value, and, based on the ejection amount reference value, determining an ejection amount minimum value, which is a minimum value of the allowable range and an ejection amount maximum value, which is a maximum value of the allowable range,
a second process for obtaining a reading result of at least a part of the plurality of patches from the reading section and, based on the reading result, determining a provisional ejection amount upper limit value, which is a provisional value of the upper limit value, and
a third process for determining the upper limit value so as to be equal to or larger than the ejection amount minimum value and equal to or smaller than the ejection amount maximum value based on the ejection amount minimum value, the ejection amount maximum value, and the provisional ejection amount upper limit value.

### BRIEF DESCRIPTION OF THE DRAWINGS

FIG. 1 is a block diagram schematically showing a configuration example of a printing device.

FIG. 2 is a diagram schematically showing an operation example of a printer.

FIG. 3 is a diagram schematically showing an example of a test pattern on a medium.

FIG. 4 is a diagram schematically showing an example of an ink ejection amount.

FIG. 5 is a diagram schematically showing an example of bleeding occurring in a patch having a line region.

FIG. 6 is a diagram schematically showing an example of ink overflow.

FIG. 7 is a diagram schematically showing an example of ink aggregation.

FIG. 8 is a diagram schematically showing a structure example of colorimetry information.

FIG. 9 is a diagram schematically showing an example of determining the ejection amount allowable range (Dt_min to Dt_max) from the ejection amount reference value Dt_goal.

FIG. 10 is a diagram schematically showing an example of a correspondence relationship between the ink ejection amount and a colorimetry value.

FIG. 11 is a flowchart schematically showing an example of an ink ejection amount upper limit value determination process.

FIG. 12 is a diagram schematically showing a display example of a UI screen.

FIG. 13 is a flowchart schematically showing an example of a printing process.

FIG. 14 is a flowchart schematically showing another example of the ink ejection amount upper limit value determination process.

FIG. 15 is a flowchart schematically showing another example of the ink ejection amount upper limit value determination process.

### DESCRIPTION OF EMBODIMENTS

Embodiments of the present disclosure will be described below. Of course, the following embodiments are merely illustrative of the present disclosure, and not all of the features shown in the embodiments are essential for the disclosed solution.

### (1) Overview of Technology Included in the Present Disclosure

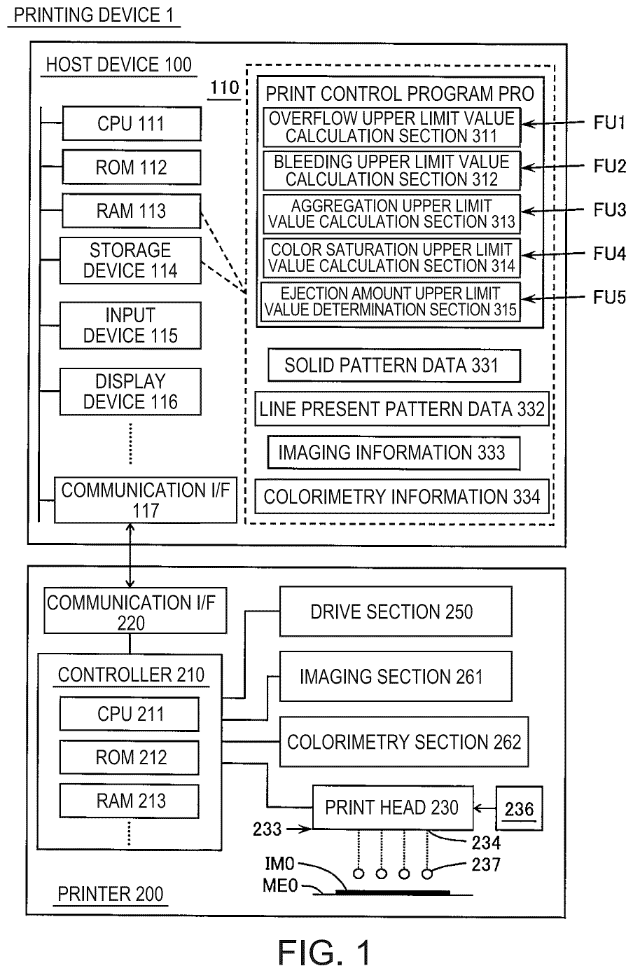

First, a summary of the techniques included in the present disclosure will be described with reference to the examples shown in FIGS. 1 to 15. Note that the drawings of the present application are diagrams that schematically show examples, and the magnification ratios in the directions illustrated in these drawings may differ, and the respective drawings may not match. Of course, each element of the present technology is not limited to specific examples indicated by reference symbols. In the “Overview of technology included in the present disclosure”, terms in parentheses mean a supplementary explanation of the immediately preceding term.

In the present application, the numerical range “Min to Max” means equal to or greater than the minimum value Min and equal to or less than the maximum value Max.

### First Aspect

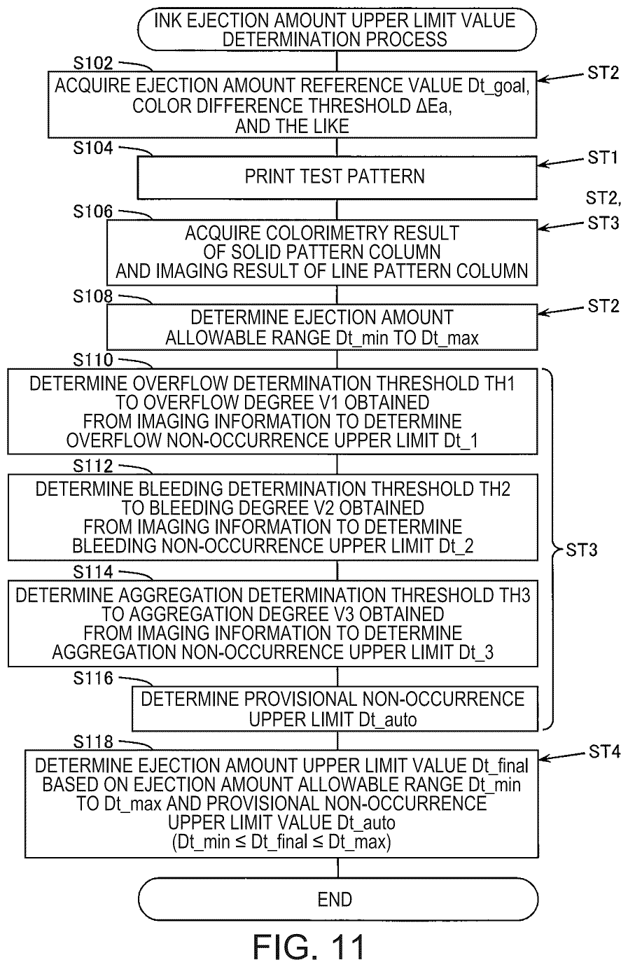

As shown in FIGS. 1 and 11, etc., an ejection amount upper limit value determination method according to one aspect of the present techniques is the ejection amount upper limit value determination method for determining an upper limit value Dt_final of an ejection amount per unit area of a liquid (for example, an ink 236) ejected from a print head 230 to a medium ME0, and includes the following steps.
(a1) A test pattern forming step ST1 of forming a test pattern 500 including a plurality of patches having different ejection amounts on the medium ME0.
(a2) An allowable range determination step ST2 for acquiring an ejection amount reference value Dt_goal that is a reference of an allowable range of the upper limit value Dt_final and determining an ejection amount minimum value Dt_min that is a minimum value of the allowable range and an ejection amount maximum value Dt_max that is a maximum value of the allowable range based on the ejection amount reference value Dt_goal.
(a3) A temporary determination step ST3 for acquiring a reading result (for example, an imaging information 333) of at least a part of the plurality of patches and determining a provisional ejection amount upper limit value Dt_auto that is a provisional value of the upper limit value Dt_final based on the reading result (333).
(A4) A first final determination step ST4 for determining the upper limit value Dt_final based on the ejection amount minimum value Dt_min, the ejection amount maximum value Dt_max, and the provisional ejection amount upper limit value Dt_auto such that the upper limit value is greater than or equal to the ejection amount minimum value Dt_min and less than or equal to the ejection amount maximum value Dt_max.

In the above described aspect, the ejection amount reference value Dt_goal that is a reference of the allowable range of the upper limit value Dt_final of the liquid ejection amount is acquired, and the allowable range (Dt_min to Dt_max) is determined based on the ejection amount reference value Dt_goal. The reading result (333) of at least a part of the plurality of patches is acquired, and the provisional ejection amount upper limit value Dt_auto is determined based on the reading result (333). Finally, the ejection amount upper limit value Dt_final is determined to be in the allowable range based on the ejection amount minimum value Dt_min, the ejection amount maximum value Dt_max, and the provisional ejection amount upper limit value Dt_auto.

From the above, the above described aspect can provide the ejection amount upper limit value determination method capable of determining the ejection amount upper limit value that takes other image quality viewpoints into consideration as much as possible while obtaining a desired coloring. As a result, for example, when the printer is switched to a new model, the color production of the new model can be adjusted to the same degree as the color production of the old model by adjusting the ejection amount reference value Dt_goal to the ejection amount upper limit value Dt_final of ink of the old model or its vicinity. At this time, the image quality viewpoints of “overflow”, “bleeding”, and “aggregation” are added to the newly determined ink ejection amount upper limit value Dt_final of ink.

Here, acquisition of the ejection amount reference value may be acceptance of an operation of inputting the ejection amount reference value, or calculation of the ejection amount reference value based on colorimetry results of a plurality of colorimetry patches having different liquid ejection amounts.

The reading result of the patch includes an image capture result of the patch by an imaging section such as a camera, a reading result of the patch by an image reading section such as a scanner, and the like.

In the present application, “first”, “second”, and so on are terms for identifying components included in a plurality of components having a similar point, and do not mean an order.

Of course, the above mentioned additional remarks also apply to the following aspects.

### Second Aspect

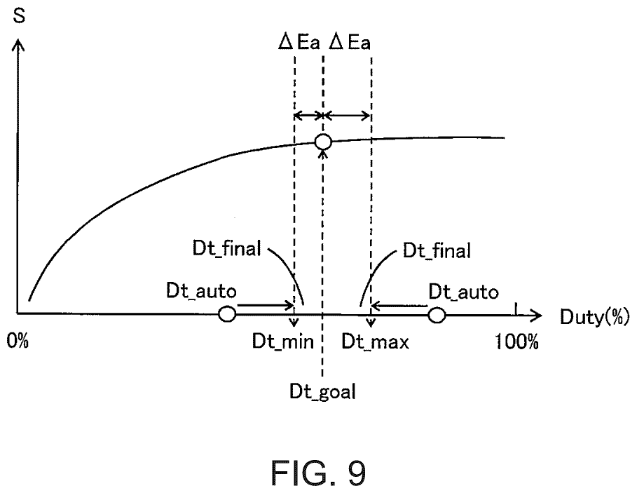

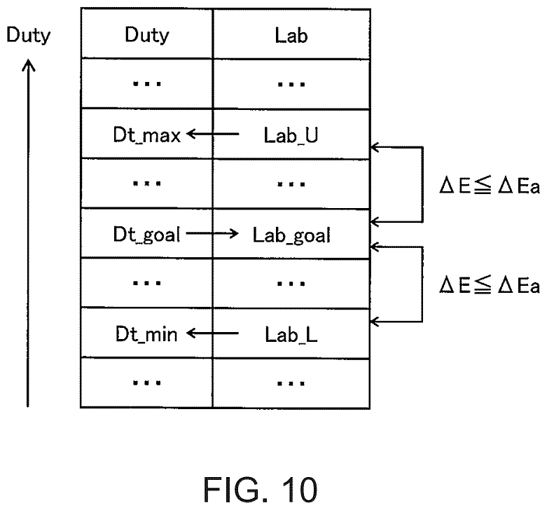

As shown in FIGS. 1 and 11, in the allowable range determination step ST2, the colorimetry result (334) that is the colorimetry result (for example, a colorimetry information 334) of at least a part of the plurality of patches and is different from the reading result (333) may be acquired. In the allowable range determination step ST2, as shown in FIGS. 9 and 10, the ejection amount minimum value Dt_min and the ejection amount maximum value Dt_max may be determined based on the colorimetry result (334) and the ejection amount reference value Dt_goal.

Since the colorimetry result (334) used for determining the allowable range for obtaining the desired coloring indicates the coloring, the above described aspect can provide a desirable example of determining the ejection amount upper limit value in which other image quality viewpoints are added as much as possible while obtaining the desired coloring.

Here, the patch for acquiring the colorimetry result may be different from the patch for acquiring the reading result or may be the same as the patch for acquiring the reading result. These mentioned additional remarks also apply to the following aspects.

### Third Aspect

As shown in FIGS. 9, 10, and 12, in the allowable range determination step ST2, an input of an allowable value (for example, threshold ΔEa) of a color difference ΔE with reference to a reference colorimetry value (for example, reference colorimetry value Lab_goal) corresponding to the ejection amount reference value Dt_goal may be received. In the allowable range determination step ST2, the ejection amount minimum value Dt_min corresponding to the lower limit of the allowable value (ΔEa) and the ejection amount maximum value Dt_max corresponding to the upper limit of the allowable value (ΔEa) may be determined with reference to the reference colorimetry value (Lab_goal) based on the colorimetry result (334) that varies depending on the ejection amount. The above described aspect can provide a more desirable example in which the ejection amount upper limit value is determined in consideration of other image quality viewpoints as much as possible while obtaining the desired coloring.

### Fourth Aspect

In the first final determination step ST4, when the provisional ejection amount upper limit value Dt_auto is larger than the ejection amount minimum value Dt_min and smaller than the ejection amount maximum value Dt_max, the upper limit value Dt_final may be determined as the provisional ejection amount upper limit value Dt_auto. In the first final determination step ST4, when the provisional ejection amount upper limit value Dt_auto is equal to or less than the ejection amount minimum value Dt_min, the upper limit value Dt_final may be determined as the ejection amount minimum value Dt_min. In the first final determination step ST4, when the provisional ejection amount upper limit value Dt_auto is equal to or larger than the ejection amount maximum value Dt_max, the upper limit value Dt_final may be determined as the ejection amount maximum value Dt_max.

The above described aspect can provide a desirable example in which the ejection amount upper limit value is determined in consideration of other image quality viewpoints as much as possible while obtaining the desired coloring.

### Fifth Aspect

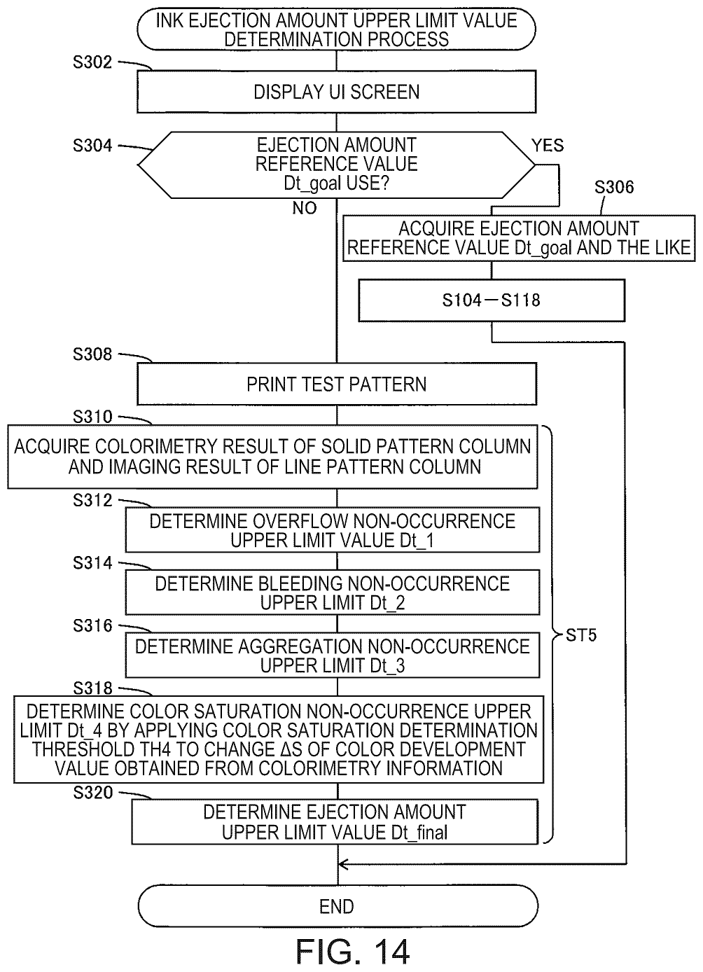

As shown in FIGS. 11 and 14, in the allowable range determination step ST2, when the processing setting is the first setting meaning the use of the ejection amount reference value Dt_goal, the ejection amount minimum value Dt_min and the ejection amount maximum value Dt_max may be determined based on the ejection amount reference value Dt_goal. In the temporary determination step ST3, when the processing setting is the first setting, the provisional ejection amount upper limit value Dt_auto may be determined based on the reading result (333). In the first final determination step ST4, when the processing setting is the first setting, the upper limit value Dt_final may be determined so as to be equal to or larger than the ejection amount minimum value Dt_min and equal to or smaller than the ejection amount maximum value Dt_max based on the ejection amount minimum value Dt_min, the ejection amount t maximum value Dt_max, and the provisional ejection amount upper limit value Dt_auto. The present ejection amount upper limit value determination method may further include the following step.
(a5) A second final determination step ST5 of, when the processing setting is the second setting meaning the not use of the ejection amount reference value Dt_goal, acquiring the colorimetry result (334) that is a colorimetry result (334) of at least a part of the plurality of patches and is different from the reading result (333), determining the first provisional ejection amount upper limit value (for example, the color saturation non-occurrence upper limit value Dt_4) that is the provisional value of the upper limit value from the viewpoint of the colorimetry result (334) based on the colorimetry result (334), acquiring the reading result (333) of at least a part of the plurality of patches, determining a second provisional ejection amount upper limit value (non-occurrence upper limit value Dt_1 to Dt_3) that is a provisional value of the upper limit value from the viewpoint of the reading result (333) based on the reading result (333), and determining the second upper limit value Dt_final based on at least one of the first provisional ejection amount upper limit value (Dt_4) and the second provisional ejection amount upper limit value (Dt_1 to Dt_3).

When the processing setting is the first setting, which means the use of the ejection amount reference value Dt_goal, the allowable range is determined based on the ejection amount reference value Dt_goal, the provisional ejection amount upper limit value Dt_auto is determined based on the reading result (333) of at least a part of the plurality of patches, and the ejection amount upper limit value Dt_final is determined so as to be within the allowable range. When the processing setting is the second setting meaning the not use of the ejection amount reference value Dt_goal, the first provisional ejection amount upper limit value (Dt_4) is determined based on the colorimetry result (334) of at least a part of the plurality of patches, the second provisional ejection amount upper limit values (Dt_1 to Dt_3) are determined based on the reading result (333) of at least a part of the plurality of patches, and the ejection amount upper limit value Dt_final is determined based on at least one of the first provisional ejection amount upper limit value (Dt_4) and the second provisional ejection amount upper limit values (Dt_1 to Dt_3). Therefore, in the above described aspect, since it is possible to select whether or not to determine the ejection amount upper limit value in consideration of other image quality viewpoints as much as possible while obtaining the desired coloring, it is possible to improve convenience.

### Sixth Aspect

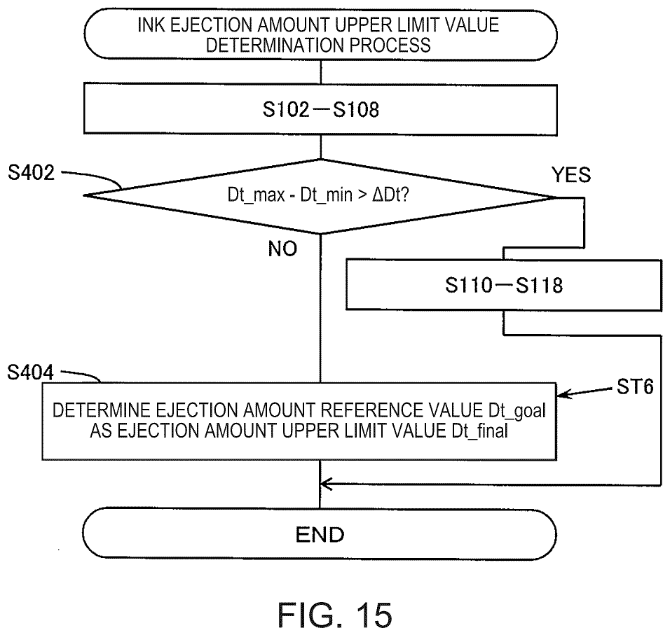

As shown in FIGS. 11 and 15, in the temporary determination step ST3, when a difference value Dt_max-Dt_min obtained by subtracting the ejection amount minimum value Dt_min from ejection amount maximum value Dt_max is larger than a predetermined value ΔDt, the provisional ejection amount upper limit value Dt_auto may be determined based on the reading result (333). In the first final determination step ST4, when the difference value Dt_max−Dt_min is larger than the predetermined value ΔDt, the upper limit value Dt_final may be determined so as to be equal to or larger than the ejection amount minimum value Dt_min and equal to or smaller than the ejection amount maximum value Dt_max based on the ejection amount minimum value Dt_min, the ejection amount maximum value Dt_max, and the provisional ejection amount upper limit value Dt_auto. The present ejection amount upper limit value determination method may further include the following step.
(a6) A third final determination step ST6 of, when the difference value Dt_max−Dt_min is equal to or smaller than the predetermined value ΔDt, the upper limit value Dt_final based on at least one of the ejection amount reference value Dt_goal, the ejection amount minimum value Dt_min, and the ejection amount maximum value Dt_max so as to be equal to or larger than the ejection amount minimum value Dt_min and equal to or smaller than the ejection amount maximum value Dt_max.

When the difference between the ejection amount maximum value Dt_max and the ejection amount minimum value Dt_min is large, the provisional ejection amount upper limit value Dt_auto is determined based on the reading result (333) of at least a part of the plurality of patches and the ejection amount upper limit value Dt_final is determined so as to be within the allowable range. When the difference between the ejection amount maximum value Dt_max and the ejection amount minimum value Dt_min is small, the ejection amount upper limit value Dt_final is determined so as to be within the allowable range based on at least one of the ejection amount reference value Dt_goal, the ejection amount minimum value Dt_min, and the ejection amount maximum value Dt_max. Therefore, when the difference between the ejection amount maximum value Dt_max and the ejection amount minimum value Dt_min is small, the above aspect can shorten the calculation time for determining the ejection amount upper limit value Dt_final.

### Seventh Aspect

As shown in FIG. 1, the printing device according to the aspect of the present technology includes the print head 230, a control section 110, and a reading section (for example, an imaging section 261). The print head 230 ejects a liquid (236) onto the medium ME0. The control section 110 performs control to form the test pattern 500 including the plurality of patches having different ejection amounts per unit area of the liquid (236) on the medium ME0 and performs process to determine the upper limit value Dt_final of the ejection amount. The reading section (261) reads at least a part of the plurality of patches. The control section 110 performs the following process as shown in FIG. 11 and the like.
(b1) A first process for acquiring the ejection amount reference value Dt_goal that is the reference of the allowable range of the upper limit value Dt_final and determining the ejection amount minimum value Dt_min that is the minimum value of the allowable range and the ejection amount maximum value Dt_max that is the maximum value of the allowable range based on the ejection amount reference value Dt_goal (for example, steps S102 and S106 to S108).
(b2) A second process for obtaining the reading result (333) of at least a part of the plurality of patches from the reading section (261) and determining the provisional ejection amount upper limit value Dt_auto, which is a provisional value of the upper limit value Dt_final, based on the reading result (333) (for example, steps S106, S110 to S116).
(b3) A third process for determining the upper limit value Dt_final so as to be equal or larger than the ejection amount minimum value Dt_min and equal to or less that the ejection amount maximum value Dt_max based on the ejection amount minimum value Dt_min, the ejection amount maximum value Dt_max, and provisional ejection amount upper limit value Dt_auto (for example, step S118).

The above aspects can provide the printing device with the capability of determining the ejection amount upper limit value in consideration of other image quality viewpoints as much as possible while obtaining the desired coloring.

Here, the reading section includes the imaging section such as the camera, the image reading section such as the scanner, and the like.

The control section may perform the process corresponding to the second to sixth aspects described above.

Furthermore, the present technology can be applied to a printing method including the above described ejection amount upper limit value determination method, a composite device including the above described printing device, an ejection amount upper limit value determination program for realizing the above described ejection amount upper limit value determination method in a computer, a print control program for realizing the above described printing method in a computer, a computer-readable recording medium in which any of the above described programs is recorded, and the like. Any of the devices described above may be comprised of multiple parts that are distributed.

### (2) Specific Example of the Configuration of the Printing Device

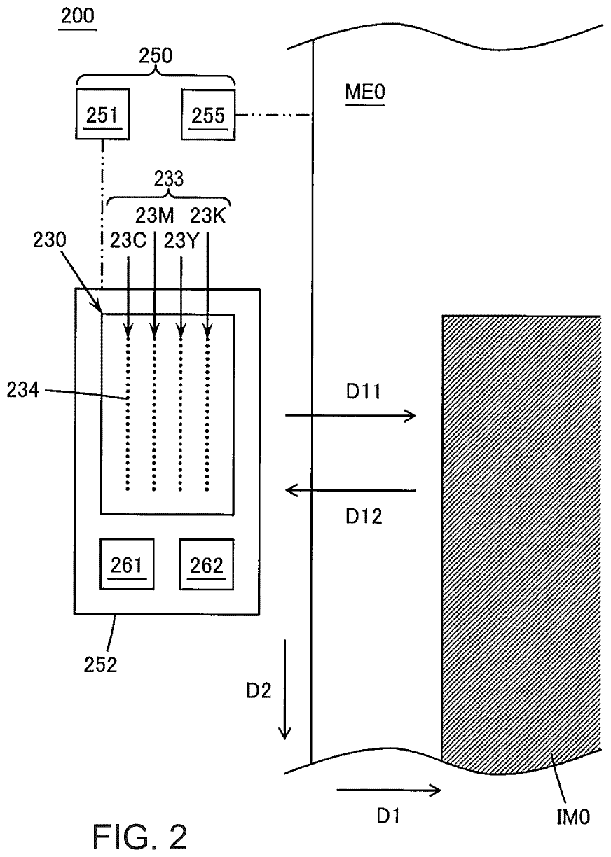

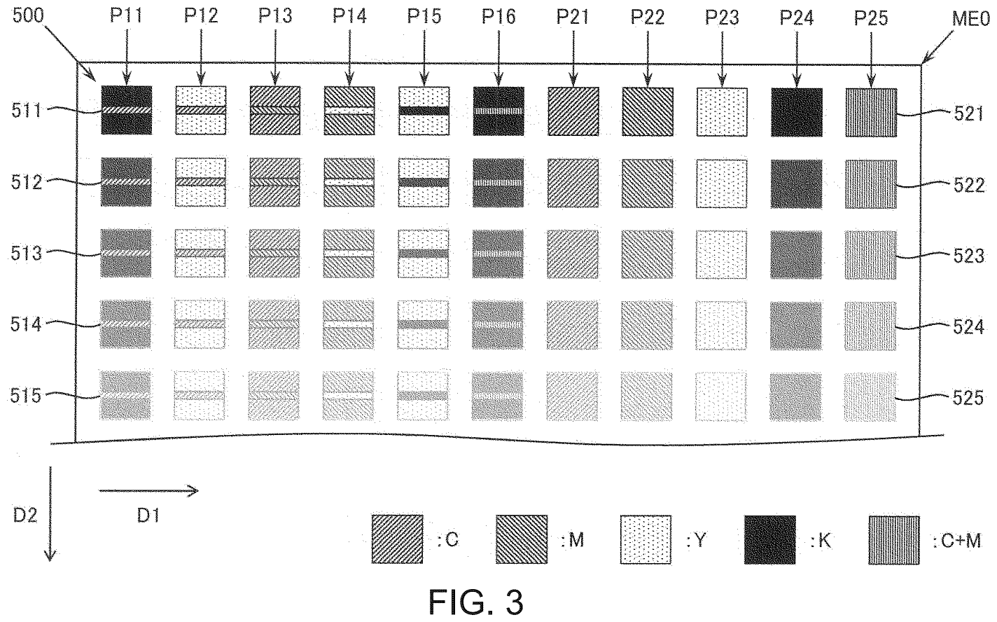

FIG. 1 schematically shows a configuration of the printing device. FIG. 2 schematically shows the operation of the printer. FIG. 3 schematically shows the test pattern on the medium.

A printing device 1 shown in FIG. 1 is a device in a broad sense including a host device 100 and a printer 200, and can be said to be a printing system. Of course, the printing device 1 may be a single printer 200. The host device 100 includes a Central Processing Unit (CPU) 111 which is a processor, a Read Only Memory (ROM) 112, a Random Access Memory (RAM) 113, a storage device 114, an input device 115, a display device 116, a communication interface (I/F) 117, and the like. The above described elements (111 to 117) are electrically connected so as to be able to input and output information to and from each other. Note that the ROM 112, the RAM 113, and the storage device 114 are memories and at least the ROM 112 and the RAM 113 are semiconductor memories. The configuration of the printer 200 will be described later.

The storage device 114 stores an operating system (OS) (not shown), a print control program PRO, solid pattern data 331, line present pattern data 332, and the like. The solid pattern data 331 is used for printing the solid pattern columns P21 to P25 included in the test pattern 500 shown in FIG. 3. The line present pattern data 332 is used for printing the line pattern columns P11 to P16 included in the test pattern 500 shown in FIG. 3. Further, the storage device 114 also stores imaging information 333 generated by the imaging section 261 of the printer 200, colorimetry information 334 generated by a colorimetry section 262 of the printer 200, and the like. As the storage device 114, a nonvolatile semiconductor memory such as a flash memory, a magnetic storage device such as a hard disk, or the like can be used. As the input device 115, a pointing device, a hard key including a keyboard, a touch panel attached to the surface of a display panel, or the like can be used. The display device 116 displays a screen corresponding to the display information based on display information. As the display device 116 can be used a liquid crystal display panel or the like. The communication I/F 117 is connected to a communication I/F 220 of the printer 200 and inputs and outputs information such as print data to and from the printer 200. The communication of the communication I/F 117 and 220 may be wired, wireless, or network communication such as Local Area Network (LAN) or the internet.

The print control program PRO causes the host device 100 to function as an overflow upper limit value calculation section 311, a bleeding upper limit value calculation section 312, an aggregation upper limit value calculation section 313, a color saturation upper limit value calculation section 314, an ejection amount upper limit value determination section 315, and the like. Details of these elements (311 to 315) will be described later. The print control program PRO causes the host device 100 to implement the overflow upper limit value calculation function FU1 corresponding to the overflow upper limit value calculation section 311, the bleeding upper limit value calculation function FU2 corresponding to the bleeding upper limit value calculation section 312, the aggregation upper limit value calculation function FU3 corresponding to the aggregation upper limit value calculation section 313, the color saturation upper limit value calculation function FU4 corresponding to the color saturation upper limit value calculation section 314, and the ejection amount upper limit value determination function FU5 corresponding to the ejection amount upper limit value determination section 315. Note that the ejection amount upper limit value can be referred to as an ejection amount limit value, and specifically, can be referred to as an ink Duty limit value.

The CPU 4 the host device 100 reads out the information stored in the storage device 114 to the RAM 113 as appropriate and executes the read out program to perform various processes. The CPU 111 executes the print control program PRO read into the RAM 113 to perform processing corresponding to the above described functions (FU1 to FU5). The CPU 111, which executes the print control program PRO, is an example of the control section 110 and executes steps corresponding to the above described functions (FU1 to FU5). The computer-readable recording medium storing the print control program PRO is not limited to a storage device inside the host device and may be a recording medium external to the host device.

Note that the host device 100 includes a computer such as a personal computer, a mobile phone such as a smartphone, a digital camera, a digital video camera, and the like. The host device 100 may have all the elements (111 to 117) in one housing, or may be composed of a plurality of devices divided so as to be able to communicate with each other. The present technology can be implemented even when at least a part of the printer 200 is in the host device 100.

The printer 200 shown in FIGS. 1 and 2 is the inkjet printer that forms a print image IMO corresponding to the print data by ejecting C ink, M ink, Y ink, and K ink as the ink 236 containing a color material from the print head 230 to the medium ME0. Here, the ink 236 is an example of a liquid, ink droplets 237 ejected from the print head 230 is an example of a liquid droplet, C means cyan, M means magenta, Y means yellow, and K means black. The printer 200 includes a controller 210, the above described communication I/F 220, the print head 230, a drive section 250, the imaging section 261, the colorimetry section 262, and the like. The imaging section 261 is an example of the reading section that reads at least a part of the plurality of patches included in the test pattern 500.

The controller 210 includes a CPU 211 that is a processor, ROM 212, RAM 213, a color conversion section, a halftone processing section, a drive signal transmission section, and the like, and controls the operations of the communication I/F 220, the print head 230, the drive section 250, the imaging section 261, the colorimetry section 262, and the like. The controller 210 controls the ejection of the ink droplets 237 by the print head 230 and the scanning by the drive section 250 based on the print data acquired from the host device 100. For example, it is assumed that the communication I/F 220 receives the print data including RGB data having integer values of 2⁸ gradations or more of R, G, and B in each pixel. Here, R means red, G means green, and B means blue. The color conversion section is capable of converting the RGB data into ink amount data having an integer value of 2⁸ gradations or more of C, M, Y, and K in each pixel. The halftone processing section can generate dot data in which the number of gradations is reduced by performing a halftone process on the ink amount data. The controller 210 may be configured by a System on a Chip (SoC) or the like.

The printer 200 shown in FIG. 2 is a serial printer that performs printing while moving a carriage 252 in both directions along a first direction D1. Of course, the printer 200 may be a line printer that is not provided with a carriage. The print head 230, the imaging section 261, and the colorimetry section 262 are mounted on the carriage 252. The drive section 250 includes a carriage drive section 251 for moving the carriage 252 in the forward direction D11 and the backward direction D12 under the control of the controller 210 and a feed section 255 for feeding the medium ME0 in a second direction D2 under the control of the controller 210. Here, the forward direction D11 and the backward direction D12 are directions along the first direction D1, the backward direction D12 is a direction opposite to the forward direction D11, and the second direction D2 is a direction orthogonal to the first direction D1.

The print head 230 includes a drive circuit, drive elements, and the like, and performs printing by ejecting the ink droplets 237 onto the medium ME0 from a plurality of nozzles 234 included in nozzle arrays 233. Here, a nozzle means a small hole from which ink droplets are ejected, and a nozzle array means an arrangement of a plurality of nozzles. As the drive element, a piezoelectric element that applies pressure to the ink in the pressure chamber that communicates with the nozzle 234, the drive element that generates bubbles in the pressure chamber by heat and ejects the ink droplets 237 from the nozzle 234, or the like can be used. A drive signal transmission section included in the controller 210 generates a drive signal based on the print data, for example, the drive signal according to dot data, and outputs the drive signal to the drive circuit of the print head 230. The drive signal corresponds to a voltage signal applied to the drive element of the print head 230. For example, when the binary dot data based on the print data is “dot formation”, the drive signal transmission section outputs the drive signal for ejecting the ink droplets for dot formation. When the dot data is quaternary data, the drive signal transmission section outputs the drive signal for ejecting the ink droplets for large dots when the dot data is “large dot formation”, outputs a drive signal for ejecting ink droplets for medium dots when the dot data is “medium dot formation”, and outputs a drive signal for ejecting ink droplets for small dots when the dot data is “small dot formation”.

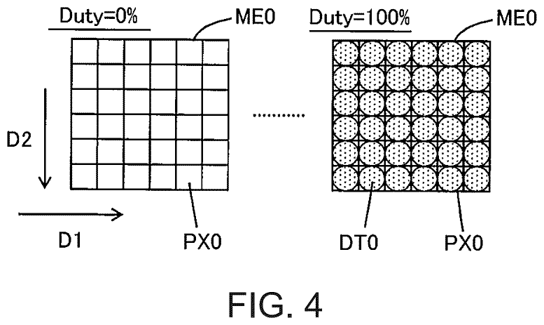

The print head 230 shown in FIG. 2 has the plurality of nozzle arrays 233 including the plurality of nozzles 234 arranged at intervals of a predetermined nozzle pitch in the second direction D2, and is disposed on a surface facing the medium ME0 in the carriage 252. Note that the arrangement direction of the plurality of nozzles 234 included in each nozzle array 233 may deviate from the second direction D2 as long as it intersects the first direction D1. The plurality of nozzle arrays 233 include a cyan nozzle array 23C that ejects C ink droplets 237, a magenta nozzle array 23M that ejects M ink droplets 237, a yellow nozzle array 23Y that ejects Y ink droplets 237, and a black nozzle array 23K that ejects K ink droplets 237. Each nozzle array 233 ejects the ink droplets 237 toward the medium ME0. The plurality of nozzles 234 included in each nozzle array 233 may be arranged in one array or may be arranged in a staggered manner, that is, in two rows. When the ink droplets 237 land on the medium ME0, dots DT0 (see FIG. 4) of the ink 236 are formed on the medium ME0. As a result, a printed product having the print image IMO on the medium ME0 is obtained.

The medium ME0 is not particularly limited and includes paper, fabric, resin, metal, and the like. The shape of the medium ME0 may be a roll shape, a cut two dimensional shape, or a three dimensional shape.

The imaging section 261 includes an area sensor, captures images of individual patches included in the test pattern 500 shown in FIG. 3, for example, patches 511 to 515, and outputs the imaging information 333, which is the imaging result, as the reading result. It can be said that the imaging section 261 of this specific example reads a part of the plurality of patches included in the test pattern 500 and that the control section 110 of this specific example acquires the reading result of a part of the plurality of patches included in the test pattern 500. The reading result is different from the colorimetry result by the colorimetry section 262. Note that the imaging section 261 may be provided with a line sensor instead of the area sensor. The imaging section 261 is disposed on the surface facing the medium ME0 in the carriage 252, and captures images when the carriage 252 moves along the first direction D1. The imaging section 261 shown in FIG. 2 is positioned in the carriage 252 at a position toward the second direction D2 from the print head 230. By this, the imaging section 261 can capture an image of the patch that was formed in a certain main scan, in a later main scan. The printer 200 transmits the imaging information 333 generated by the imaging section 261 to the host device 100. The host device 100 may store the received imaging information 333 in the storage device 114 as it is or may store, in the storage device 114, updated imaging information 333 to which additional information obtained from the received imaging information 333 was added.

The colorimetry section 262 performs colorimetry on individual patches included in the test pattern 500 shown in FIG. 3, for example, patches 521 to 525, and outputs colorimetry information 334 as a colorimetry result corresponding to the colors of the patches. It can be said that the colorimetry section 262 of this specific example measures colors of a part of the plurality of patches included in the test pattern 500 and that the control section 110 of this specific example acquires the colorimetry result of a part of the plurality of patches included in the test pattern 500. The colorimetry result is different from the imaging result by the imaging section 261. The colorimetry information 334 is, for example, a color value representing the lightness L* and the chromaticity coordinates a* and b* in the international commission on illumination (CIE) L*a*b* color space. Hereinafter, the symbol “*” will be omitted. Of course, the colorimetry information 334 may be the color value or the like in the CIE XYZ color space. The colorimetry section 262 is disposed on the surface facing the medium ME0 in the carriage 252, and performs color measure when the carriage 252 moves along the first direction D1. The colorimetry section 262 shown in FIG. 2 is positioned in the carriage 252 at a position toward the second direction D2 from the print head 230. By this, the colorimetry section 262 can measure the color of a patch that was formed in a certain main scan, in a later main scan. The printer 200 transmits the colorimetry information 334 generated by the colorimetry section 262 to the host device 100. The host device 100 may store the received colorimetry information 334 in the storage device 114 as it is or may store, in the storage device 114, the updated colorimetry information 334 to which additional information obtained from the received colorimetry information 334 was added.

As shown in FIG. 3, the test pattern 500 includes line pattern columns P11 to P16 and solid pattern columns P21 to P25. In the example shown in FIG. 3, the pattern columns (P11 to 16 and P21 to 25) are arranged in the first direction D1, and a plurality of patches included in each of the pattern columns (P11 to 16 and P21 to 25), for example, the patches 511 to 515 are arranged in the second direction D2. Of course, the arrangement direction of the pattern columns and the arrangement direction of the patches in the pattern columns are not limited to the example shown in FIG. 3, for example, the pattern columns may be arranged in the second direction D2 and the patches in the pattern columns may be arranged in the first direction D1.

First, the configuration of the solid pattern columns P21 to P25 will be described. The solid pattern columns P21 to P25 can be used to determine the upper limit value of the ink ejection amount at which the color saturation of the ink 236 does not occur.

FIG. 4 is a diagram for explaining a schematic example of the ink ejection amount (Duty). In the example shown in FIG. 4, 6×6=36 pixels PX0 are shown as the predetermined number of pixels PX0 corresponding to the unit areas. Of course, the predetermined number corresponding to the unit area is not limited to 36 and a larger area may be treated as the unit area. On the left side of FIG. 4, an example is shown in which the ink droplets 237 are not yet ejected to the predetermined number of pixels PX0 corresponding to the unit area. On the right side of FIG. 4, there is shown an example in which dots DT0 of ink of a primary color are formed in all pixels PX0 corresponding to the unit area. Pixels PX0 are the smallest element of an image to which a color can be independently assigned. A primary color is a color expressed by only one type of ink.

Ink ejection amount means the total amount of ink ejected per unit area. In other words the ink ejection amount Duty is a ratio (including a percentage) of the number of the ink droplets 237 ejected to a predetermined number of pixels PX0 and, when ink droplets 237 having different sizes are ejected to the pixel PX0, it means the ratio when converted to the largest ink droplet. For example, when Nd ink droplets 237 are ejected for 100 pixels, the ink ejection amount Duty is Nd %. When, as shown on the left side of FIG. 4, ink droplets 237 are not ejected to the predetermined number of pixels PX0, then Duty=0% and when, as shown on the right side of FIG. 4, the ink droplets 237 of the primary color are ejected to all the pixels PX0, then Duty=100%. Note that when a mixed-color image of a secondary color or the like is formed, since a plurality of types of the ink droplets 237 are ejected to one pixel PX0, in some cases, Duty>100%. For example, the ink ejection amount Duty of a secondary color is 200% at the maximum. A secondary color is a color expressed by two types of ink having different colors.

“Ink color saturation” means a phenomenon in which coloring with respect to the ink ejection amount does not substantially change, in other words, a phenomenon in which coloring does not substantially change even if the ink ejection amount increases. “Coloring” means the density of the print image such as a patch, and is expressed as the lightness L in the Lab color space subtracted from 100 (100−L), as the saturation (a²+b²)^{1/2} obtained from the chromaticity coordinates a and b, or the like. Each solid pattern column P21 to P25 shown in FIG. 3 includes a plurality of patches, for example, the rectangular patches 521 to 525, in which the ink ejection amount changes stepwise. In the solid pattern column P25, the ink ejection amount decreases in the order of the patches 521, 522, 523, 524, and 525. Also in the remaining solid pattern columns P21 to P24, the lower the patch is, the smaller the ink ejection amount is. Note that the solid pattern column P21 includes a plurality of patches in which the ejection amount of the C ink gradually decreases from 100%. The solid pattern column P22 includes a plurality of patches in which the ejection amount of the M ink gradually decreases from 100%. The solid pattern column P23 includes the plurality of patches in which the ejection amount of the Y ink gradually decreases from 100%. The solid pattern column P24 includes a plurality of patches in which the ejection amount of the K ink gradually decreases from 100%. In the solid pattern columns P21 to P24 of the primary colors, the interval between the ink ejection amounts of the patches is not particularly limited and may be an interval of 5%, an interval of 10%, or the like. The solid pattern column P25 includes the plurality of patches in which the combined ejection amount of the C ink and the M ink decreases from 200% in a stepwise manner. In the solid pattern column P25 of the secondary color, the interval of the ink ejection amounts of the patches is not particularly limited and may be an interval of 10%, an interval of 20%, or the like.

Of course, the solid pattern column is not limited to the example shown in FIG. 3. For example, the test pattern 500 may include a solid pattern column of a tertiary color formed by C ink, M ink, and Y ink or may include a solid pattern column of the secondary color formed by C ink and Y ink, or the like.

The line pattern columns P11 to P16 can be used to determine an “overflow non-occurrence upper limit value”, a “bleeding non-occurrence upper limit value”, and an “aggregation non-occurrence upper limit value”. “Overflow non-occurrence upper limit value” means the upper limit value of the ink ejection amount at which the ink overflow does not occur. “Overflow of ink” means a phenomenon wherein, during the drying process of ink that was ejected onto a certain region of the medium ME0, ink accumulates in peripheral portions of the region and the ink becomes denser in the peripheral portions than in the central portion in the region. “Bleeding non-occurrence upper limit value” means an upper limit value of the ink ejection amount at which ink bleeding does not occur. “Bleeding of ink” means a phenomenon in which ink ejected onto a certain region of the medium ME0 is not absorbed by the medium ME0, and an ink pool forms in an outline portion of the region, resulting in unevenness. “Aggregation non-occurrence upper limit value” means an upper limit value of ink ejection amount at which the ink aggregation does not occur. “Ink aggregation” means a phenomenon in which the dispersibility of the dots DT0 formed on the medium ME0 by the ink droplets landed on the medium ME0 is reduced. When the dispersibility of the dots DT0 decreases, the graininess of the region increases, and the image quality decreases.

The line pattern columns P11 to P16 have a configuration similar to that of the solid pattern columns P21 to P25, except for the configuration of each patch.

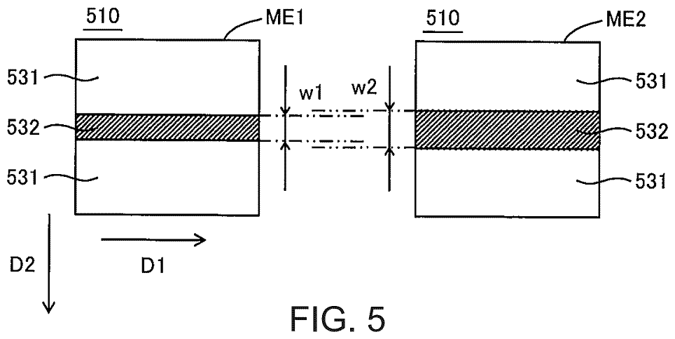

FIG. 5 schematically shows a patch having a line region. A patch 510 shown in FIG. 5 is representative of the patches 511 to 515 shown in FIG. 3. Therefore, the structure of the patches 511 to 515 will be described with reference to the patch 510 shown in FIG. 5. Note that the left side of FIG. 5 shows the patch 510 in which ink bleeding has not occurred. The right side of FIG. 5 shows the patch 510 with ink bleeding. Bleeding of ink will be described later.

The patch 510 includes two solid regions 531 and a line region 532 between the solid regions 531. Each solid region 531 is a rectangular solid image of a color different from that of the line region 532 and is in contact with the line region 532. In the patch 510 shown in FIG. 5, the plurality of solid regions 531 have the same color. The two solid regions 531 shown in FIG. 5 are divided into upper and lower portions but, for example, may be divided into left and right portions. The number of solid regions 531 included in each patch 510 may be three or more. The solid regions 531 are used to determine the presence or absence of ink overflow and the presence or absence of ink aggregation. The line region 532 is a line-shaped solid image of a color different from that of the solid region 531 and is in contact with both solid regions 531. The line region 532 is used to determine the presence or absence of ink bleeding.

The line pattern columns P11 to P16 shown in FIG. 3 include a plurality of patches, for example, rectangular patches 511 to 515, in which the ink ejection amount to the solid regions 531 and the line region 532 changes stepwise. Note that the line pattern column P11 includes a plurality of patches in which the ejection amount of the K ink corresponding to the solid regions 531 gradually decreases from 100% and the ejection amount of the C ink corresponding to the line region 532 gradually decreases from 100%. The line pattern column P12 includes a plurality of patches in which the ejection amount of the Y ink corresponding to the solid regions 531 gradually decreases from 100% and the ejection amount of the C ink corresponding to the line region 532 gradually decreases from 100%. The line pattern column P13 includes a plurality of patches in which the ejection amount of the C ink corresponding to the solid regions 531 gradually decreases from 100% and the ejection amount of the M ink corresponding to the line region 532 gradually decreases from 100%. The line pattern column P14 includes a plurality of patches in which the ejection amount of the M ink corresponding to the solid regions 531 gradually decreases from 100% and the ejection amount of the Y ink corresponding to the line region 532 gradually decreases from 100%. The line pattern column P15 includes a plurality of patches in which the ejection amount of the Y ink corresponding to the solid regions 531 gradually decreases from 100% and the ejection amount of the K ink corresponding to the line region 532 gradually decreases from 100%. The line pattern column P16 includes a plurality of patches in which the ejection amount of the K ink corresponding to the solid regions 531 decreases stepwise from 100%, and the combined ejection amount of the C ink and the M ink corresponding to the line region 532 decreases stepwise from 200%. When the solid regions 531 and the line region 532 are a primary color, the interval between the ink ejection amounts of the patches is not particularly limited and may be an interval of 5%, an interval of 10%, or the like. When the solid regions 531 and the line region 532 are a secondary color, the interval between the ink ejection amounts of the patches is not particularly limited and may be an interval of 10%, an interval of 20%, or the like.

Of course, the line pattern column is not limited to the example shown in FIG. 3. For example, the test pattern 500 may include a line pattern column in which the line region 532 has a tertiary color, or may include a line pattern column in which the solid regions 531 have a secondary color.

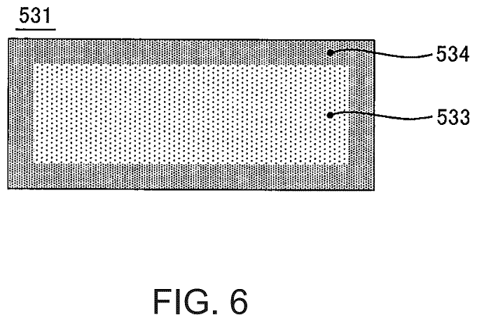

FIG. 6 schematically shows ink overflow in a solid region 531.

When ink overflow occurs in a solid region 531 on the medium ME0, in the solid region 531, the color of the peripheral portion 534 becomes denser than the color of the central portion 533 that is surrounded by the peripheral portion 534. When the peripheral portion 534 is denser than the central portion 533, the peripheral portion 534 has a lower lightness L than the central portion 533, the peripheral portion 534 has a smaller RGB value than the central portion 533, and the peripheral portion 534 has a larger CMYK value than the central portion 533 and, when the solid region 531 is a chromatic color, the peripheral portion 534 has a higher saturation than the central portion 533. The greater the ink ejection amount, the more likely that ink overflow will occur.

When the imaging section 261 shown in FIG. 1 captures an image of the solid regions 531, then, based on the imaging information 333, the overflow upper limit value calculation section 311 can obtain an overflow degree V1 (see FIG. 11) that is the difference between the detected density indicating the density of the peripheral portion 534 and the detected density indicating the density of the central portion 533. The overflow upper limit value calculation section 311 compares the overflow degree V1 with the overflow determination threshold TH1 (see FIG. 11), for example, when V1≥TH1, it determines that ink overflow has occurred, and V1<YH1, it determines that ink overflow has not occurred. The overflow upper limit value calculation section 311 obtains the maximum ink ejection amount that satisfies V1<TH1 as the overflow non-occurrence upper limit value Dt_1 (see FIG. 11) for each line pattern column P11 to P16.

The overflow determination threshold TH1 (TH1>0) used for determining the presence or absence of ink overflow can be determined in advance by a plurality of testers performing a sensory evaluation of the plurality of test patterns printed on the medium ME0 (persons performing the sensory evaluation). For example, as shown in FIG. 6, the plurality of types of test patterns including solid regions 531 having a difference in detection density between the peripheral portion 534 and the central portion 533 are prepared in accordance with the difference in detection density, and are printed on the medium ME0. The tester visually checks the plurality of types of test patterns printed on the medium ME0 and performs a sensory evaluation, such as selecting a patch in which a difference in detected density can be visually recognized. The overflow determination threshold TH1 is determined by statistically analyzing the results of performing the same sensory evaluation by the plurality of testers. When the overflow determination threshold TH1 is finally determined from the analysis results, a histogram in which the differences between the detected densities are represented by bins may be created and the differences between the detected densities of the peak frequencies may be set as the overflow determination threshold TH1 or weighted averages may be set as the overflow determination threshold TH1. A design specification of the printing device 1 may be added to the overflow determination threshold TH1. By determining the presence or absence of the ink overflow according to the obtained overflow determination threshold TH1, a result suitable for a human sense is obtained. The determined overflow determination threshold TH1 is stored in the storage device 114.

FIG. 5 schematically shows bleeding occurring in the patch 510. The left side of FIG. 5 shows the patch 510 formed on a medium ME1 through which ink does not easily bleed. The right side of FIG. 5 shows the patch 510 that is formed on a medium ME2 in which ink easily bleeds. For example, glossy paper is an example of the medium ME1 through which ink does not easily bleed, and a plain paper and cloth are examples of the medium ME2 in which ink easily bleeds.

In an outline portion of the line region 532 formed on the medium ME1 on which ink does not easily bleed, there is no unevenness due to bleeding. In an outline portion of the line region 532 formed on the medium ME2 on which ink easily bleeds, unevenness due to bleeding is observed. In the medium ME2 in which ink easily bleeds, by ink of the line region 532 bleeding to the periphery, a width w2 of the line region 532 formed on the medium ME2 becomes wider than a width w1 of the line region 532 formed on the medium ME1 in which ink does not easily bleed. Therefore, the width of the line region 532 indicates a bleeding degree V2 (see FIG. 11), and it can be said that the greater the width of the line region 532 is, the greater the degree of bleeding is. The greater the ink ejection amount, the more likely that ink bleeding will occur.

When the imaging section 261 shown in FIG. 1 captures an image of the patch 510, the bleeding upper limit value calculation section 312 can acquire the width of the line region 532 as the bleeding degree V2 based on the imaging information 333. The bleeding upper limit value calculation section 312 compares the bleeding degree V2 with the bleeding determination threshold TH2 (see FIG. 11), for example, when V2>TH2, it determines that ink bleeding has occurred, and when V2<TH2, it determines that ink bleeding has not occurred. The bleeding upper limit value calculation section 312 obtains the maximum ink ejection amount that satisfies V2<TH2 as the bleeding non-occurrence upper limit value Dt_2 (see FIG. 11) for each line pattern column P11 to P16.

The bleeding determination threshold TH2 (TH2>0) used for determining the presence or absence of ink bleeding can be determined in advance by a plurality of testers performing the sensory evaluation of the plurality of test patterns printed on the medium ME0. For example, as shown in FIG. 5, the plurality of types of test patterns including the patch 510 are prepared corresponding to the degree of the widths of the line regions 532 and are printed on the medium ME0. The tester visually checks the plurality of types of test patterns printed on the medium ME0 and performs the sensory evaluation such as selecting a patch in which the occurrence of ink bleeding can be visually recognized. The bleeding determination threshold TH2 is determined by statistically analyzing the results of performing the same sensory evaluation by the plurality of testers. When the bleeding determination threshold TH2 is finally determined from the analysis result, a histogram in which the width of the line region 532 as a bin may be created, and the width of the peak frequency may be set as the bleeding determination threshold TH2 or a weighted average value may be set as the bleeding determination threshold TH2. The design specification of the printing device 1 may be added to the bleeding determination threshold TH2. By determining the presence or absence of ink bleeding according to the obtained bleeding determination threshold TH2, a result suitable for the human sense is obtained. The determined bleeding determination threshold TH2 is stored in the storage device 114.

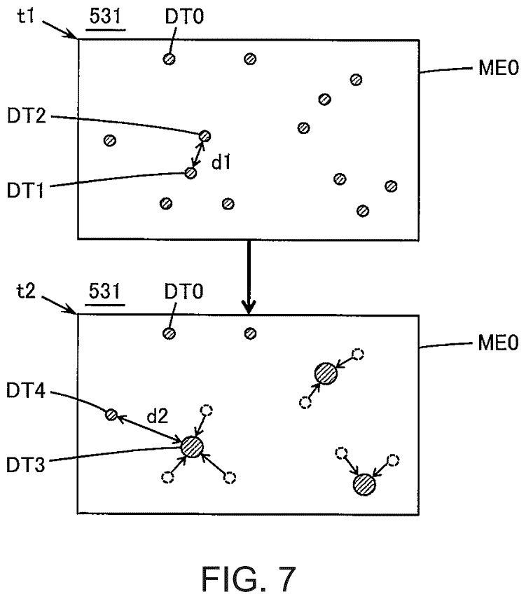

FIG. 7 schematically shows the ink aggregation in a solid region 531. The upper part of FIG. 7 shows a pattern of the dots DT0 at the timing t1 at the moment when the ink droplets 237 land on the medium ME0. The lower part of FIG. 7 shows a pattern of the dots DT0 at the timing t2 at which the plurality of dots DT0 that are not fixed on the medium ME0 are attracted and gathered.

When the medium ME0 easily absorbs ink, like plain paper or the like, as shown in the upper part of FIG. 7, the dots DT0 are fixed to the medium ME0 with the pattern at the timing t1. Here, among the plurality of dots DT0, a certain dot DT1 and a dot DT2 closest to the dot DT1 will be focused on. When the medium ME0 cannot easily absorb ink, such as a film or coated paper, as shown in the lower part of FIG. 7, a plurality of dots DT0 close to each other attract and gather to change into one large dot, for example, a dot DT3. This phenomenon is ink aggregation. Note that the dot DT3 shown in the lower portion of FIG. 7 corresponds to the dot DT1 in the upper portion of FIG. 7, and a dot DT4 shown in the lower portion of FIG. 7 is at a position closest to the dot DT3. In the example shown in FIG. 7, it is shown that a plurality of dots centered on the dot DT1, including the dot DT2, change into the large dot DT3. As a result, a distance d2 between the dot DT3 and the dot DT4 is longer than a distance d1 between the dot DT1 and the dot DT2. The greater the ink ejection amount, the more likely that ink aggregation will occur.

When the imaging section 261 shown in FIG. 1 captures an image of the solid regions 531, the aggregation upper limit value calculation section 313 can determine, based on the imaging information 333, at least one of a representative value of a dot size and a representative value of a distance between the dots as the aggregation degree V3 (see FIG. 11). The representative value of the dot size may be an arithmetic mean value of the dot size, a peak value of the dot size, or the like. The representative value of the distance between the dots may be an arithmetic mean value of the distance between the dots, a peak value of the distance between the dots, or the like. The aggregation degree V3 may be a representative value obtained by combining the size of dots and the distance between dots. The aggregation upper limit value calculation section 313 compares the aggregation degree V3 with the aggregation determination threshold TH3 (see FIG. 11), for example, when V3>TH3, it determines that ink aggregation has occurred, and when V3<TH3, it determines that ink aggregation has not occurred. The aggregation upper limit value calculation section 313 obtains the maximum ink ejection amount that satisfies V3<TH3 as the aggregation non-occurrence upper limit value Dt_3 (see FIG. 11) for each line pattern column P11 to P16.

The aggregation determination threshold TH3 (TH3>2) used for determining the presence or absence of ink aggregation can be determined in advance by a plurality of testers performing sensory evaluation of the plurality of test patterns printed on the medium ME0. For example, as shown in FIG. 7, the plurality of types of test patterns including the solid regions 531 in which ink aggregation occurs are prepared corresponding to the degree of ink aggregation and are printed on the medium ME0. The tester visually checks the plurality of types of test patterns printed on the medium ME0 and performs a sensory evaluation such as selecting a patch in which the occurrence of the ink aggregation can be visually recognized. The aggregation determination threshold TH3 is determined by statistically analyzing the results of performing the same sensory evaluation by the plurality of testers. When the aggregation determination threshold TH3 is finally determined from the analysis result, a histogram in which the aggregation degree V3 as a bin may be created, and the aggregation degree V3 of the peak frequency may be set as the aggregation determination threshold TH3 or a weighted average value may be set as the aggregation determination threshold TH3. The design specification of the printing device 1 may be added to the aggregation determination threshold TH3. By determining the presence or absence of ink aggregation according to the obtained aggregation determination threshold TH3, a result suitable for the human sense is obtained. The determined aggregation determination threshold TH3 is stored in the storage device 114.

When a final ejection amount upper limit value is determined based on at least one of the overflow non-occurrence upper limit value Dt_1, the bleeding non-occurrence upper limit value Dt_2, and the aggregation non-occurrence upper limit value Dt_3, improvement in the image quality of the print image IMO is expected, but the coloring of the print image IMO may be insufficient. This is because the final ejection amount upper limit value might be smaller than the upper limit value of the ink ejection amount at which color saturation of ink does not occur, and in this case, the coloring ability of ink is not sufficiently exhibited.

When the printer 200 is switched to a new model, there is a need to maintain the color production of the old model in the new model. In this specific example, while maintaining the color production of the print image IMO to the same level as that of the old model, the final ejection amount upper limit value is determined taking into consideration the quality of ink overflow, ink bleeding, and ink aggregation, which are related to the image quality of the print image IMO. As shown in FIGS. 9 and 10, the host device 100 of this specific example performs a process of determining the ejection amount allowable range (Dt_min to Dt_max) based on the ejection amount reference value Dt_goal based on the color production and the like of the old model and determining the final ejection amount upper limit value Dt_final within the ejection amount allowable range.

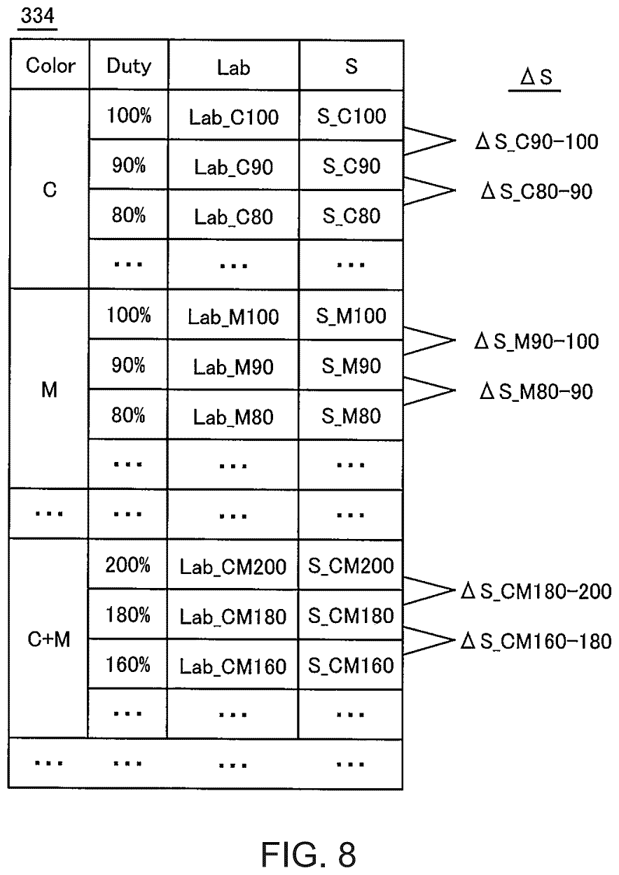

First, an example of the structure of the colorimetry information 334 stored in the storage device 114 will be described with reference to FIG. 8.

In FIG. 8, “Color” indicates the color of the solid pattern columns P21 to P25 of FIG. 3, “Duty” indicates the ink ejection amount, “Lab” indicates the colorimetry value, “S” indicates the value representing coloring, and “ΔS” indicates the change in a coloring value S between the ink ejection amounts Duty. For example, in the solid pattern column P21 of C, the colorimetry value Lab of Duty=100% is indicated by “Lab_C100” and the coloring value S of Duty=100% is indicated by “S_C100”. In the solid pattern column P25 of C and M, the colorimetry value Lab of Duty=200% is indicated by “Lab_CM200” and the coloring value S of Duty=200% is indicated by “S_CM200”.

With respect to the solid pattern columns P21 to P25, the host device 100 receives, from the printer 200, colorimetry information including the colorimetry value Lab associated with the ink ejection amount Duty and stores, in the storage device 114, the colorimetry information 334 including the coloring value S calculated from the colorimetry value Lab as the additional information. The coloring value S may be (100−L) based on the lightness L included in the colorimetry value Lab or may be saturation or the like based on the chromaticity coordinates a and b included in the colorimetry value Lab.

The color saturation of ink can be represented by a change ΔS in the coloring value S due to a change in the ink ejection amount Duty in each solid pattern column P21 to P25. For example, in the solid pattern column P21 of C, the change ΔS_C80-90 of the coloring value S when the ink ejection amount Duty increases from 80% to 90% is S_C90−S_C80, and the change ΔS_C90-100 of the coloring value S when the ink ejection amount Duty increases from 90% to 100% is S_C100−S_C90. The host device 100 can determine whether or not color saturation has occurred by applying a color saturation determination threshold (TH4) to the change ΔS in the coloring value S. For example, the host device 100 can determine that the color saturation has occurred in the case of ΔS>TH4 and can determine that the color saturation has not occurred in the case of ΔS<TH4.

FIG. 9 schematically shows how the ejection amount allowable range (Dt_min to Dt_max) is determined from the ejection amount reference value Dt_goal, which is the reference for the allowable range of the ejection amount upper limit value Dt_final. In FIG. 9, a horizontal axis represents the ink ejection amount Duty and a vertical axis represents the coloring value S. FIG. 10 schematically shows a correspondence relationship between the ink ejection amount Duty and the colorimetry value Lab.

In this specific example, in order to maintain the color production of the new model of the printer 200 at the same level as the color production of the old model, the target ejection amount reference value Dt_goal is set first. The ejection amount reference value Dt_goal is set for each primary color and secondary color, for example. Note that the ejection amount reference value Dt_goal may also be set for a tertiary color, may be set for each of the primary colors C, M, Y, and K, or may be set for each combination of secondary colors. When the target is the old model, the ejection amount reference value Dt_goal may be the ejection amount upper limit value determined by the old model, or may be the ejection amount upper limit value determined from the measurement result of the test pattern formed by the old model. In addition, the ejection amount reference value Dt_goal may be set according to a user's request regardless of the old model.

The host device 100 sets the ejection amount allowable range (Dt_min to Dt_max) based on each ejection amount reference value Dt_goal. Here, as shown in FIG. 10, the colorimetry value Lab of the solid patch whose ink ejection amount Duty is the ejection amount reference value Dt_goal is set as a reference colorimetry value Lab_goal, the colorimetry value Lab of the solid patch whose ink ejection amount Duty is the ejection amount minimum value Dt_min is set as Lab L, the colorimetry value Lab of the solid patch whose ink ejection amount Duty is the ejection amount maximum value Dt_max is set as Lab U, and the color difference ΔE based on the reference colorimetry value Lab_goal is set as ΔEa. The color difference ΔE may be a color difference formula ΔE2000 of CIE DE2000, or may be the square root of the sum of the square of the square of the L value, the square of the value, and the square of the b value. The host device 100 determines the ink ejection amount Duty of the patch having the smallest ink ejection amount Duty among the patches in which the color difference ΔE is equal to or less than the threshold ΔEa to be the ejection amount minimum value Dt_min. The ejection amount minimum value Dt_min corresponds to a lower limit of an allowable value represented by the threshold ΔEa of the color difference ΔE with reference to the reference colorimetry value Lab_goal. The host device 100 determines the ink ejection amount Duty in the patch having the largest ink ejection amount Duty among the patches in which the color difference ΔE is equal to or less than the threshold ΔEa to be the ejection amount maximum value Dt_max. The ejection amount maximum value Dt_max corresponds to an upper limit of the allowable value represented by the threshold ΔEa of the color difference ΔE with reference to the reference colorimetry value Lab_goal. Note that the threshold ΔEa of the color difference ΔE can be determined in advance by a plurality of testers performing sensory evaluation on the plurality of patches printed on the medium ME0. In general, when the color difference ΔE between the patches is about 2, it can be said that there is almost no color difference between the patches. Therefore, the threshold ΔEa may be about 2.

Further, the host device 100 determines the provisional ejection amount upper limit value Dt_auto based on at least one of the non-occurrence upper limit values (Dt_1 to Dt_3) of the viewpoints other than the coloring. The provisional ejection amount upper limit value Dt_auto may be within the ejection amount allowable range (Dt_min to Dt_max) or may be outside the ejection amount allowable range (Dt_min to Dt_max). Therefore, the host device 100 determines the final ejection amount upper limit value Dt_final in the ejection amount allowable range (Dt_min to Dt_max) based on the ejection amount allowable range (Dt_min to Dt_max) and the provisional ejection amount upper limit value Dt_auto. The ejection amount upper limit value Dt_final is determined, for example, as follows.

```
If Dt_auto ≤ Dt_min,
  then Dt_final = Dt_min.
If Dt_min < Dt_auto < Dt_max,
  then Dt_final = Dt_auto.
If Dt_auto ≥ Dt_max,
  then Dt_final = Dt_max.
```

The above determination method is merely an example. For example, an ejection amount slightly larger than the ejection amount minimum value Dt_min within the ejection amount allowable range (Dt_min to Dt_max) may be set as Dt_amin, and when Dt_auto≤Dt_amin, the ejection amount upper limit value Dt_final may be determined as the ejection amount Dt_amin. An ejection amount slightly smaller than the ejection amount maximum value Dt_max within the ejection amount allowable range (Dt_min to Dt_max) may be set as Dt_amax, and when Dt_auto>Dt_amax, the ejection amount upper limit value Dt_final may be determined as the ejection amount Dt_amax.

### (3) Specific Example of the Ink Ejection Amount Upper Limit Value Determination Process

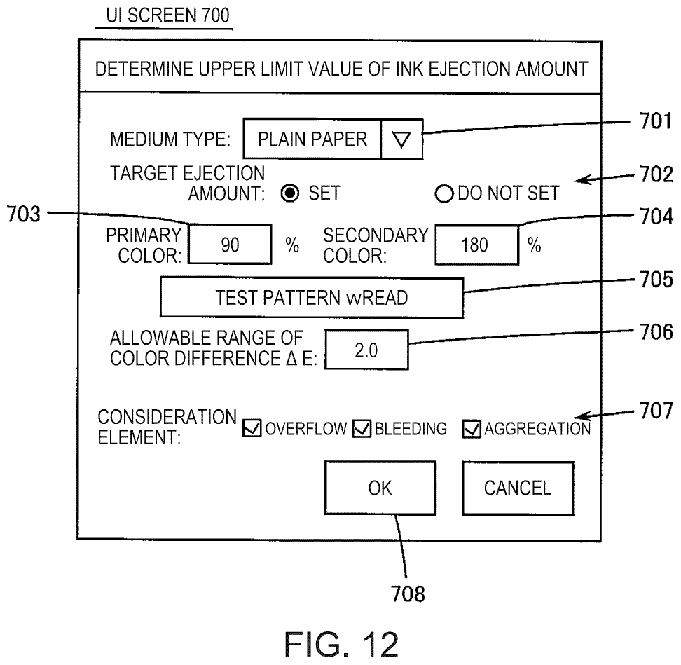

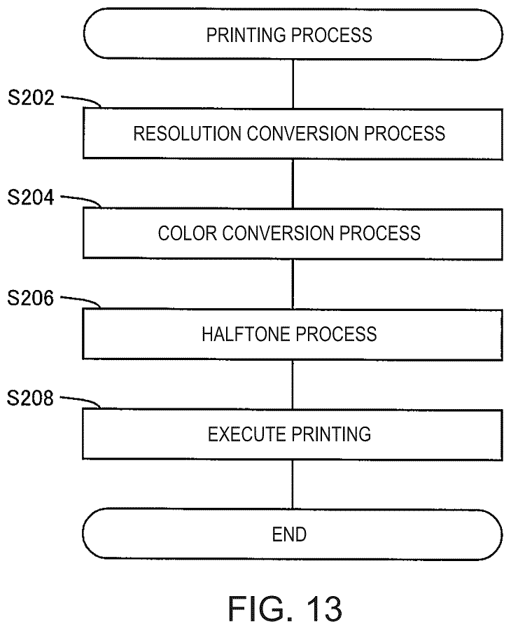

FIG. 11 schematically shows the ink ejection amount upper limit value determination process for determining the ejection amount upper limit value Dt_final. FIG. 12 schematically shows a User Interface (UI) screen displayed in step S102 of the ink ejection amount upper limit value determination process. FIG. 13 schematically shows the printing process performed by the printer 200 in step S104 of the ink ejection amount upper limit value determination process. The ink ejection amount upper limit value determination process will be described below with reference to FIGS. 1 to 10.

The ink ejection amount upper limit value determination process of the present embodiment is performed by the host device 100 including the control section 110 as shown in FIG. 1. The ink ejection amount upper limit value determination process is started when the host device 100 receives an operation for determining the ejection amount upper limit value Dt_final in the input device 115. Here, steps S102 to S108 and S116 to S118 correspond to the ejection amount upper limit value determination section 315 and the ejection amount upper limit value determination function FU5. Step S110 corresponds to the overflow upper limit value calculation section 311 and the overflow upper limit value calculation function FU1. Step S112 corresponds to the bleeding upper limit value calculation section 312 and the bleeding upper limit value calculation function FU2. Step S114 corresponds to the aggregation upper limit value calculation section 313 and the aggregation upper limit value calculation function FU3. Step S104 corresponds to the test pattern forming step ST1. Steps S102 and S106 to S108, correspond to the allowable range determination step ST2. Steps S106 and S110 to S116 correspond to the temporary determination step ST3. Step S118 corresponds to the first final determination step ST4. Hereinafter, the word “step” may be omitted, and reference symbol of steps may be indicated in parentheses.

When the ink ejection amount upper limit value determination process starts, the host device 100 displays the UI screen 700 shown in FIG. 12 on the display device 116 and acquires the ejection amount reference value Dt_goal, the threshold ΔEa of the color difference ΔE, and the like (S102). The UI screen 700 has a medium type selection field 701, a target setting selection region 702, a primary color ejection amount reference value input field 703, a secondary color ejection amount reference value input field 704, a test pattern read button 705, an allowable color difference input field 706, a consideration element selection region 707, an OK button 708, and the like.

In the medium type selection field 701, the host device 100 accepts the setting of any one medium type from among medium types, such as plain paper, photo paper, cloth, and the like. The user can select any one of the plurality of medium types by operating the medium type selection field 701 with the input device 115.

In the target setting selection region 702, the host device 100 accepts the selection of either “set” or “do not set”. The user can select “set” or “do not set” by operating the target setting selection region 702 with the input device 115. When the host device 100 receives “set”, it performs the process of S104 to S118. When the host device 100 receives “do not set”, it does not set the ejection amount allowable range (Dt_min to Dt_max) and determines the ejection amount upper limit value Dt_final by performing another process not shown in FIG. 11. This “other process” will be described later.

In the primary color ejection amount reference value input field 703, the host device 100 receives the input of the ejection amount reference value Dt_goal for the primary color. The user can input the ejection amount reference value Dt_goal for the primary color by operating the primary color ejection amount reference value input field 703 with the input device 115. Note that the primary color ejection amount reference value input field 703 may be provided for each primary color.

In the secondary color ejection amount reference value input field 704, the host device 100 receives the input of the ejection amount reference value Dt_goal for the secondary color. The user can input the ejection amount reference value Dt_goal for the secondary color by operating the secondary color ejection amount reference value input field 704 with the input device 115. Note that the secondary color ejection amount reference value input field 704 may be provided for each secondary color. Of course, the host device 100 may receive an input of the ejection amount reference value Dt_goal for a tertiary color in a tertiary color ejection amount reference value input field (not shown).

The test pattern read button 705 is an operation area for determining the ejection amount reference value Dt_goal of the primary color and the secondary color by measuring the test pattern 500 formed by the old model of the printer 200. When the operation of the test pattern read button 705 is received, the host device 100 may cause the colorimetry section 262 to measure colors of the solid pattern columns of the old model and cause the imaging section 261 to capture an image of the line pattern columns of the old model. Then, the host device 100 may determine the “color saturation non-occurrence upper limit value” based on the colorimetry information 334, determine the non-occurrence upper limit values (Dt_1 to Dt_3) based on the imaging information 333, and determine the ejection amount reference value Dt_goal based on at least one of the “color saturation non-occurrence upper limit value” and the non-occurrence upper limit values (Dt_1 to Dt_3).

In the allowable color difference input field 706, the host device 100 receives an input of the threshold ΔEa of the color difference ΔE with reference to the reference colorimetry value Lab_goal corresponding to the ejection amount reference value Dt_goal. The user can input the threshold ΔEa by operating the allowable color difference input field 706 with the input device 115. The host device 100 may display a default threshold ΔEa in the allowable color difference input field 706. Note that the allowable color difference input field 706 may be provided separately for the primary color and the secondary color.

In the consideration element selection region 707, the host device 100 accepts settings on whether to consider “ink overflow”, whether to consider “ink bleeding”, and whether to consider “ink aggregation”. The user can select whether or not to consider “ink overflow”, whether or not to consider “ink bleeding”, and whether or not to consider “ink aggregation” by operating the consideration element selection region 707 with the input device 115.

When the host device 100 accepts the operation of the OK button 708 by the input device 115, it holds the operation content to the UI screen 700 in at least one of the RAM 113 and the storage device 114. By this, the host device 100 acquires the ejection amount reference value Dt_goal and acquires the threshold ΔEa of the color difference ΔE. After the S102, the host device 100 performs a process of causing the printer 200 to print the test pattern 500 including the plurality of patches having different ink ejection amounts Duty (S104). The host device 100 transmits the solid pattern data 331 and the line present pattern data 332 shown in FIG. 1 to the printer 200. Here, it is assumed that these sets of data (331 and 332) are RGB data. As shown in FIG. 13, the printer 200 first performs a resolution conversion process for converting the solid pattern data 331 and the line present pattern data 332 into a print resolution (S202). When these sets of data (331 and 332) are at the print resolution, the resolution conversion process is not necessary. Next, the printer 200 performs a color conversion process for converting the solid pattern data 331 and the line present pattern data 332 into ink amount data (S204). Note that when these sets of data (331 and 332) are the ink amount data, the color conversion process is not necessary. Next, the printer 200 performs a halftone process for converting the ink amount data into binary or quaternary dot data (S206). Note that when the solid pattern data 331 and the line present pattern data 332 are dot data, the halftone process is not necessary. If necessary, the printer 200 performs a rasterization process for rearranging the dot data into the printing order. Finally, the printer 200 generates a drive signal in accordance with the dot data and forms the test pattern 500 including the solid pattern columns P21 to P25 corresponding to the solid pattern data 331 and the line pattern columns P11 to P16 corresponding to the line present pattern data 332 on the medium ME0 (S208).

Note that the process of S202 to S206 may be performed by the host device 100, the process of S202 to S204 may be performed by the host device 100, and the process of S202 may be performed by the host device 100.

After the test pattern 500 is printed, the host device 100 causes the printer 200 to perform color measure and imaging and acquires, from the printer 200, colorimetry information 334 of the solid pattern columns P21 to P25 and imaging information 333 of the line pattern columns P11 to P16 (S106). The printer 200 that has received the instructions for color measure and imaging feeds the medium ME0 backward, performs color measure on the patches included in the solid pattern columns P21 to P25 using the colorimetry section 262, and captures images of the patches included in the line pattern columns P11 to P16 using the imaging section 261. When the printer 200 transmits the colorimetry information 334 from the colorimetry section 262 and the imaging information 333 from the imaging section 261 to the host device 100, the host device 100 acquires the colorimetry information 334 and the imaging information 333 and stores them in the storage device 114. As shown in FIG. 8, the host device 100 calculates the coloring value S from the colorimetry value Lab and adds the coloring value S to the colorimetry information 334.

Next, the host device 100 determines the ejection amount allowable range (Dt_min to Dt_max) based on the colorimetry information 334 and the ejection amount reference value Dt_goal, which are different depending on the ink ejection amount Duty (S108). As shown in FIGS. 9 and 10, the host device 100 determines the ink ejection amount Duty of the patch having the smallest ink ejection amount Duty among the patches in which the color difference ΔE is equal to or smaller than the threshold ΔEa to be the ejection amount minimum value Dt_min. The host device 100 determines the ink ejection amount Duty in the patch having the largest ink ejection amount Duty among the patches in which the color difference ΔE is equal to or less than the threshold ΔEa to be the ejection amount maximum value Dt_max.

Next, the host device 100 obtains the overflow degree V1 based on the imaging information 333 and determines the overflow non-occurrence upper limit value Dt_1 by determining the overflow determination threshold TH1 to the overflow degree V1 (S110). For example, the overflow upper limit value calculation section 311 shown in FIG. 1 first obtains the maximum ink ejection amount at which V1<TH1 for each line pattern column P11 to P16 as the overflow non-occurrence upper limit value. Next, the overflow upper limit value calculation section 311 determines the overflow non-occurrence upper limit value Dt_1 of the primary color based on the overflow non-occurrence upper limit values of the line pattern columns P11 to P15 of the primary color and determines the overflow non-occurrence upper limit value Dt_1 of the secondary color based on the overflow non-occurrence upper limit value of the line pattern column P16 of the secondary color. The overflow non-occurrence upper limit value Dt_1 of the primary color may be the smallest value of the overflow non-occurrence upper limit values of the line pattern columns P11 to P15 or may be the mean value of the overflow non-occurrence upper limit values of the line pattern columns P11 to P15. The overflow non-occurrence upper limit value Dt_1 of the secondary color can also be calculated in the same manner as the overflow non-occurrence upper limit value Dt_1 of the primary color.

Next, the host device 100 obtains the bleeding degree V2 based on the imaging information 333 and determines the bleeding non-occurrence upper limit value Dt_2 by determining the bleeding determination threshold TH2 to the bleeding degree V2 (S112). For example, the bleeding upper limit value calculation section 312 shown in FIG. 1 first obtains the maximum ink ejection amount at which V2<TH2 for each line pattern column P11 to P16 as the bleeding non-occurrence upper limit value. Next, the bleeding upper limit value calculation section 312 determines the bleeding non-occurrence upper limit value Dt_2 of the primary color based on the bleeding non-occurrence upper limit value of the line pattern columns P11 to P15 of the primary color and determines the bleeding non-occurrence upper limit value Dt_2 of the secondary color based on the bleeding non-occurrence upper limit value of the line pattern column P16 of the secondary color. The bleeding non-occurrence upper limit value Dt_2 of the primary color may be the smallest value of the bleeding non-occurrence upper limit values of the line pattern columns P11 to P15 or may be the mean value of the bleeding non-occurrence upper limit values of the line pattern columns P11 to P15. The bleeding non-occurrence upper limit value Dt_2 of the secondary color can also be calculated in the same manner as the bleeding non-occurrence upper limit value Dt_2 of the primary color.

Next, the host device 100 determines the aggregation degree V3 based on the imaging information 333 and determines the aggregation non-occurrence upper limit value Dt_3 by determining the aggregation determination threshold TH3 to the aggregation degree V3 (S114). For example, the aggregation upper limit value calculation section 313 shown in FIG. 1 first obtains the maximum ink ejection amount at which V3<TH3 for each line pattern column P11 to P16 as the aggregation non-occurrence upper limit value. Next, the aggregation upper limit value calculation section 313 determines the aggregation non-occurrence upper limit value Dt_3 of the primary color based on the aggregation non-occurrence upper limit value of the line pattern columns P11 to P15 of the primary color and determines the aggregation non-occurrence upper limit value Dt_3 of the secondary color based on the aggregation non-occurrence upper limit value of the line pattern column P16 of the secondary color. The aggregation non-occurrence upper limit value Dt_3 of the primary color may be the smallest value of the aggregation non-occurrence upper limit values of the line pattern columns P11 to P15 or may be the mean value of the aggregation non-occurrence upper limit values of the line pattern columns P11 to P15. The aggregation non-occurrence upper limit value Dt_3 of the secondary color can also be calculated in the same manner as the aggregation non-occurrence upper limit value Dt_3 of primary color.

Next, the host device 100 determines the provisional ejection amount upper limit value Dt_auto, which is a provisional value of the ejection amount upper limit value Dt_final, based on at least one of the non-occurrence upper limit values (Dt_1 to Dt_3) (S116). For example, when a plurality of items are selected in the consideration element selection region 707 shown in FIG. 12, the host device 100 may determine the minimum value or the average value of the non-occurrence upper limit value corresponding to the selected items as the provisional ejection amount upper limit value Dt_auto. When the number of items selected in the consideration element selection region 707 shown in FIG. 12 is one, the host device 100 may determine the non-occurrence upper limit value corresponding to the selected item as the provisional ejection amount upper limit value Dt_auto.

As described above, the host device 100 determines the provisional ejection amount upper limit value Dt_auto based on the imaging information 333.

Finally, the host device 100 determines the ejection amount upper limit value Dt_final based on the ejection amount minimum value Dt_min, the ejection amount maximum value Dt_max, and the provisional ejection amount upper limit value Dt_auto so as to be equal to or larger than the ejection amount minimum value Dt_min and equal to or smaller than the ejection amount maximum value Dt_max (S118).

```
If Dt_auto ≤ Dt_min,
  then Dt_final = Dt_min.
If Dt_min < Dt_auto < Dt_max,
  then Dt_final = Dt_auto.
If Dt_auto ≥ Dt_max,
  then Dt_final = Dt_max.
```

For example, the host device 100 determines the ejection amount upper limit value Dt_final for the primary color in accordance with the above described equation and determines the ejection amount upper limit value Dt_final for the secondary color in accordance with the above described equation.

The determined ejection amount upper limit value Dt_final is used for creating a color conversion LUT to be referred to at the time of the color conversion process.

From the above, the ejection amount upper limit value Dt_final is determined in the allowable range (Dt_min to Dt_max) based on the ejection amount reference value Dt_goal and is determined by taking into consideration image quality viewpoints other than the coloring as much as possible in this allowable range (Dt_min to Dt_max). Therefore, in this specific example, it is possible to determine the upper limit value of the ejection amount in which other image quality viewpoints are taken into consideration as much as possible while obtaining the desired coloring. As a result, when the printer is switched to the new model, the color production of the new model can be adjusted to the same degree as the color production of the old model by adjusting the ejection amount reference value Dt_goal to the ejection amount upper limit value Dt_final of the old model or its vicinity. At this time, the image quality viewpoint such as “overflow”, “bleeding”, or “aggregation” is added to the newly determined ejection amount upper limit value Dt_final.

### (4) Application Example

The printing device 1 may be capable of performing the processes of S102 to S118 shown in FIG. 11, and may determine the ejection amount upper limit value Dt_final without performing at least part of the processes of S102 to S118.

FIG. 14 schematically shows the ink ejection amount upper limit value determination process including a process performed when “do not set” is selected in the target setting selection region 702 shown in FIG. 12. Here, S302 and S306 correspond to S102 shown in FIG. 11. S310 to S320 correspond to the second final determination step ST5. When “set” is selected in the target setting selection region 702, it means that the processing setting is the first setting, which means the use of the ejection amount reference value Dt_goal. When “do not set” is selected in the target setting selection region 702, it means that the processing setting is the second setting, which means the ejection amount reference value Dt_goal is not used.

When the ink ejection amount upper limit value determination process shown in FIG. 14 starts, the host device 100 displays the UI screen 700 shown in FIG. 12 on the display device 116 (S302). Next, the host device 100 judges whether or not to use the ejection amount reference value Dt_goal (S304). When “set” is selected in the target setting selection region 702 shown in FIG. 12, the host device 100 acquires the ejection amount reference value Dt_goal, the threshold ΔEa of the color difference ΔE, and the like from the ejection amount reference value input fields (703, 704) (S306), and performs the processes of S104 to S118 shown in FIG. 11. Therefore, when the processing setting is the first setting, the host device 100 determines the allowable range (Dt_min to Dt_max) based on the colorimetry information 334 and the ejection amount reference value Dt_goal and determines the provisional ejection amount upper limit value Dt_auto based on the imaging information 333. Then, the host device 100 determines the ejection amount upper limit value Dt_final based on the allowable range (Dt_min to Dt_max) and the provisional ejection amount upper limit value Dt_auto so as to be equal to or larger than the ejection amount minimum value Dt_min and equal to or smaller than the ejection amount maximum value Dt_max.

When “do not set” is selected in the target setting selection region 702 shown in FIG. 12, the host device 100 performs a process of causing the printer 200 to print the test pattern 500 in the same manner as the process of S104 shown in FIG. 11 (S308). Next, the host device 100 acquires the colorimetry information 334 of the solid pattern columns P21 to P25 and the imaging information 333 of the line pattern columns P11 to P16 from the printer 200 in the same manner as the process of S106 shown in FIG. 11 (S310). Next, the host device 100 determines the overflow non-occurrence upper limit value Dt_1 by determining the overflow determination threshold TH1 to the overflow degree V1 obtained from the imaging information 333 in the same manner as the process of S110 shown in FIG. 11 (S312). Next, the host device 100 determines the bleeding non-occurrence upper limit value Dt_2 by determining the bleeding determination threshold TH2 to the bleeding degree V2 obtained from the imaging information 333 in the same manner as the process of S112 shown in FIG. 11 (S314). Next, the host device 100 determines the aggregation non-occurrence upper limit value Dt_3 by determining the aggregation determination threshold TH3 to the aggregation degree V3 obtained from the imaging information 333 in the same manner as the process of S114 shown in FIG. 11 (S316).

The non-occurrence upper limit values (Dt_1 to Dt_3) are examples of the second provisional ejection amount upper limit value that is a provisional value of the ejection amount upper limit value from the viewpoint of the imaging information 333.

Next, the host device 100 obtains the change ΔS based on the coloring value S (see FIG. 8) obtained from the colorimetry information 334 from the colorimetry section 262 and determines the color saturation non-occurrence upper limit value Dt_4 by determining the color saturation determination threshold TH4 (TH4>0) to the change ΔS (S318). The color saturation non-occurrence upper limit value Dt_4 means the upper limit value of the ink ejection amount at which color saturation of ink does not occur. The color saturation determination threshold TH4 used to determining the presence or absence of color saturation of ink can be determined in advance by a plurality of testers performing a sensory evaluation on the plurality of test patterns printed on the medium ME0. For example, the tester visually checks a plurality of types of solid pattern columns printed on the medium ME0, and performs the sensory evaluation such as selecting a patch in which the occurrence of color saturation of ink can be visually recognized. The color saturation determination threshold TH4 is determined by statistically analyzing the results of performing the same sensory evaluation by the plurality of testers. When the color saturation determination threshold TH4 is finally determined from the analysis result, a histogram in which the change ΔS of the coloring value S is set as a bin may be created, and the width of the peak frequency may be set as the color saturation determination threshold TH4 or a weighted average value may be set as the color saturation determination threshold TH4. The design specification of the printing device 1 may be added to the color saturation determination threshold TH4. By determining the presence or absence of ink bleeding according to the obtained color saturation determination threshold TH4, a result suitable for the human sense is obtained. The determined color saturation determination threshold TH4 is stored in the storage device 114.

For example, the color saturation upper limit value calculation section 314 shown in FIG. 1 first obtains the maximum ink ejection amount at which ΔS<TH4 for each solid pattern column P21 to P25 as the color saturation non-occurrence upper limit value. Next, the color saturation upper limit value calculation section 314 determines the color saturation non-occurrence upper limit value Dt_4 of the primary color based on the color saturation non-occurrence upper limit value of the solid pattern columns P21 to P24 of the primary color and determines the color saturation non-occurrence upper limit value Dt_4 of the secondary color based on the color saturation non-occurrence upper limit value of the solid pattern columns P25 of the secondary color. The color saturation non-occurrence upper limit value Dt_4 of the primary color may be the smallest value of the color saturation non-occurrence upper limit values of the solid pattern columns P21 to P24 or may be the mean value of the color saturation non-occurrence upper limit values of the solid pattern columns P21 to P24. The color saturation non-occurrence upper limit value Dt_4 of the secondary color can also be calculated in the same manner as the color saturation non-occurrence upper limit value Dt_4 of the primary color.

The color saturation non-occurrence upper limit value Dt_4 is an example of a first provisional ejection amount upper limit value that is a provisional value of the ejection amount upper limit value from the viewpoint of the colorimetry information 334.

Finally, the host device 100 determines the ejection amount upper limit value Dt_final on the basis of at least one of the color saturation non-occurrence upper limit value Dt_4 from the viewpoint of the colorimetry information 334 and the non-occurrence upper limit values (Dt_1 to Dt_3) from the viewpoint of the imaging information 333 (S320). For example, when “do not set” is selected in the target setting selection region 702 of the UI screen 700 shown in FIG. 12, “Ink color saturation” is considered and the item selected in the consideration element selection region 707 is considered for other image quality elements. When the plurality of items are selected in the consideration element selection region 707, the host device 100 may determine the minimum value or the average value of the non-occurrence upper limit values corresponding to the selected items as the second provisional ejection amount upper limit value. In this case, the host device 100 may determine the smaller value of the color saturation non-occurrence upper limit value Dt_4 and the second provisional ejection amount upper limit value or the average value of the color saturation non-occurrence upper limit value Dt_4 and the second provisional ejection amount upper limit value as the ejection amount upper limit value Dt_final. When no item is selected in the consideration element selection region 707, the host device 100 may determine the color saturation non-occurrence upper limit value Dt_4 as the ejection amount upper limit value Dt_final.

In addition, when “do not set” is selected in the target setting selection region 702 of the UI screen 700 shown in FIG. 12, it is assumed that “ink color saturation” is not taken into consideration and items selected in the consideration element selection region 707 are taken into consideration for other image quality elements. When a plurality of items are selected in the consideration element selection region 707, the host device 100 may determine the smallest value or the average value of the non-occurrence upper limit values corresponding to the selected items as the second provisional ejection amount upper limit value and further as the ejection amount upper limit value Dt_final.

In the example shown in FIG. 14, it is possible to select whether or not to determine the ejection amount upper limit value in consideration of other image quality viewpoints as much as possible while obtaining a desired coloring, so that convenience can be improved.

FIG. 15 schematically shows an ink ejection amount upper limit value determination process that omits the processes of S110 to S118 for determining the provisional ejection amount upper limit value Dt_auto 1 when Dt_min=Dt_max or the allowable range (Dt_min to Dt_max) is narrow in the allowable range determining process of S108 shown in FIG. 11. Here, S404 corresponds to the third final determination step ST6.

When the ink ejection amount upper limit value determination process shown in FIG. 15 starts, the host device 100 performs the processes of S102 to S108 shown in FIG. 11 to determine the ejection amount minimum value Dt_min and the ejection amount maximum value Dt_max. Here, a threshold for the difference value Dt_max−Dt_min obtained by subtracting the ejection amount minimum value Dt_min from the ejection amount maximum value Dt_max is set to the predetermined value ΔDt (ΔDt>0).

Next, the host device 100 judges whether or not the difference value Dt_max−Dt_min is larger than the predetermined value ΔDt (S402).

When Dt_max−Dt_min>ΔDt, the host device 100 performs the processes of S110 to S118 shown in FIG. 11. Therefore, when Dt_max−Dt_min>ΔDt, the host device 100 determines the provisional ejection amount upper limit value Dt_auto based on the imaging information 333 and determines, based on the allowable range (Dt_min to Dt_max) and the provisional ejection amount upper limit value Dt_auto, the ejection amount upper limit value Dt_final so as to be equal to or more than the ejection amount minimum value Dt_min and equal to or less than the ejection amount maximum value Dt_max.

When Dt_max−Dt_min≤ΔDt, the host device 100 determines the ejection amount reference value Dt_goal to be the ejection amount upper limit value Dt_final (S404) and terminates the ink ejection amount upper limit value determination process. Note that in S404, the host device 100 may determine the ejection amount minimum value Dt_min or the ejection amount maximum value Dt_max as the ejection amount upper limit value Dt_final. In step S404, the host device 100 may determine an average value of the ejection amount reference value Dt_goal and the ejection amount minimum value Dt_min, an average value of the ejection amount reference value Dt_goal and the ejection amount maximum value Dt_max, an average value of the ejection amount reference value Dt_goal, the ejection amount minimum value Dt_min, and the ejection amount maximum value Dt_max, and the like as the ejection amount upper limit value Dt_final.

When Dt_max−Dt_min≤ΔDt, even when the processes of S110 to S118 shown in FIG. 11 are performed, the degree to which the image quality viewpoints of “overflow”, “bleeding”, and “aggregation” are added is small. Therefore, in the example shown in FIG. 15, when Dt_max−Dt_min≤ΔDt, the calculation time for determining the ejection amount upper limit value Dt_final can be shortened.

Note that when the threshold ΔEa of the color difference ΔE is as small as, for example, 1 or less, Dt_min=Dt_max is satisfied or the allowable range (Dt_min to Dt_max) is narrowed in the allowable range determination process of S108 shown in FIG. 11, and the Dt_max−Dt_min≤ΔDt is normally obtained. Therefore, when the threshold ΔEa acquired in the process of S102 shown in FIG. 11 is equal to or less than the second predetermined value (for example, a value of 0 or more and 1 or less), the host device 100 may omit the processes of S110 to S118 for determining the provisional ejection amount upper limit value Dt_auto. When the threshold ΔEa acquired in the process of S102 is equal to or less than the second predetermined value, the host device 100 may determine the ejection amount reference value Dt_goal as the ejection amount upper limit value Dt_final without performing the processes of S104 to S118.

### (4) Modifications

Various modifications of the present disclosure are conceivable.

For example, the combination of ink colors is not limited to C, M, Y, and K, and may include one or more colors selected from Lc (light cyan) lower in density than C, Lm (light magenta) lower in density than M, Dy (dark yellow) higher in density than Y, Lk (light black) lower in density than K, Or (orange), Gr (green), a transparent color, and the like, in addition to C, M, Y, and K. The present technique can also be applied to the case where a part of C, M, Y, and K is not included in the color combination of ink.

That which performs the ink ejection amount upper limit value determination process is not limited to the CPU, and may be an electronic component other than the CPU, such as an Application Specific Integrated Circuit (ASIC). Of course, a plurality of CPUs may cooperatively perform the ink ejection amount upper limit value determination process, or a CPU and another electronic component (for example, the ASIC) may cooperatively perform the ink ejection amount upper limit value determination process. The above described process can be changed as appropriate, such as by changing the order. For example, in the ink ejection amount upper limit value determination process shown in FIG. 11, the process of S102 may be performed immediately after the process of S104 or S106, and the order of the processes of S110, S112, and S114 can be arbitrarily changed.

In the above described process, for example, the judgment of whether or not “equal to or more than” can be replaced with the judgment of whether or not “larger than”, and the judgment of whether or not “smaller than” can be replaced with the judgment of whether or not “equal to or less than”. It is also included in the present technology that the judgment is replaced as described above.

The reading section that reads at least a part of the plurality of patches included in the test pattern 500 is not limited to the imaging section 261 and may be an image reading section such as a scanner.

The control section 110 may obtain the overflow degree V1 and the aggregation degree V3 based on the reading results of the plurality of patches included in the solid pattern columns P21 to P25. Therefore, the reading section such as the imaging section 261 may read all the patches included in the test pattern 500 and the control section 110 may determine the provisional ejection amount upper limit value Dt_auto based on the reading result of all the patches.

The control section 110 may determine the allowable range (Dt_min to Dt_max) based on the colorimetry result of the solid regions 531 of the patch 510 shown in FIG. 5 and the ejection amount reference value Dt_goal. Therefore, the colorimetry section 262 may measure color of all the patches included in the test pattern 500 and the control section 110 may determine the allowable range (Dt_min to Dt_max) based on the colorimetry results of all the patches and the ejection amount reference value Dt_goal.

Instead of the allowable value of the color difference ΔE between patches, the control section 110 may determine the allowable range (Dt_min to Dt_max) based on an allowable value of a lightness difference between patches, an allowable value of a saturation difference between patches, and the like.

The control section 110 may determine the allowable range (Dt_min to Dt_max) based on the ejection amount reference value Dt_goal without using the colorimetry result of the patch. For example, the control section 110 may determine the ejection amount minimum value Dt_min to a value obtained by subtracting the ejection amount difference allowable value from the ejection amount reference value Dt_goal using the positive ejection amount difference allowable value based on the ejection amount reference value Dt_goal and may determine the ejection amount maximum value Dt_max to a value obtained by adding the ejection amount difference allowable value to the ejection amount reference value Dt_goal.

### (5) Conclusions

As described above, according to various aspects of the present disclosure, it is possible to provide a technique or the like capable of determining the ejection amount upper limit value in which other image quality viewpoints are added as much as possible while obtaining the desired coloring. Of course, the above described basic operations and effects can be obtained even with a technology consisting only of the constituent elements according to the independent claims.

A configuration in which the respective configurations disclosed in the above mentioned examples are replaced with each other or combinations thereof are changed, a configuration in which the respective configurations disclosed in the publicly known art and the above mentioned examples are replaced with each other or combinations thereof are changed, and the like can be implemented. The present disclosure also includes these configurations.

What is claimed is:

1. An ejection amount upper limit value determination method for determining an upper limit value of an ejection amount per unit area of a liquid ejected from a print head to a medium, the method comprising:
a test pattern forming step for forming on the medium a test pattern including a plurality of patches having different ejection amounts;
an allowable range determination step for acquiring an ejection amount reference value, which is a reference of an allowable range of the upper limit value, and determining, based on the ejection amount reference value, an ejection amount minimum value, which is a minimum value of the allowable range, and an ejection amount maximum value, which is a maximum value of the allowable range;
a temporary determination step for acquiring a reading result of at least a part of the plurality of patches and, based on the reading result, determining a provisional ejection amount upper limit value, which is a provisional value of the upper limit value; and
a first final determination step for determining the upper limit value based on the ejection amount minimum value, the ejection amount maximum value, and the provisional ejection amount upper limit value such that the upper limit value is greater than or equal to the ejection amount minimum value and less than or equal to the ejection amount maximum value.

2. The ejection amount upper limit value determination method according to claim 1, wherein
in the allowable range determination step, the colorimetry result that is a colorimetry result of at least a part of the plurality of patches and that is different from the reading result is acquired and the ejection amount minimum value and the ejection amount maximum value are determined based on the colorimetry result and the ejection amount reference value.

3. The ejection amount upper limit value determination method according to claim 2, wherein
in the allowable range determination step, an input of an allowable value of a color difference with a reference colorimetry value corresponding to the ejection amount reference value as a reference is received, and the ejection amount minimum value corresponding to a lower limit of the allowable value and the ejection amount maximum value corresponding to an upper limit of the allowable value are determined with the reference colorimetry value as a reference based on the colorimetry results that differ according to the ejection amount.

4. The ejection amount upper limit value determination method according to claim 1, wherein
in the first final determination step
when the provisional ejection amount upper limit value is larger than the ejection amount minimum value and smaller than the ejection amount maximum value, the upper limit value is determined to be the provisional ejection amount upper limit value,
when the provisional ejection amount upper limit value is equal to or less than the ejection amount minimum value, the upper limit value is determined to be the ejection amount minimum value, and
when the provisional ejection amount upper limit value is equal to or larger than the ejection amount maximum value, the upper limit value is determined to be the ejection amount maximum value.

5. The ejection amount upper limit value determination method according to claim 1, wherein
when a processing setting is a first setting meaning the use of the ejection amount reference value, then in the ejection amount upper limit value determination method,
in the allowable range determination step, the ejection amount minimum value and the ejection amount maximum value are determined based on the ejection amount reference value,
in the temporary determination step, the provisional ejection amount upper limit value is determined based on the reading result, and
in the first final determination step, the upper limit value is determined based on the ejection amount minimum value, the ejection amount maximum value, and the provisional ejection amount upper limit value so as to be equal to or larger than the ejection amount minimum value and equal to or smaller than the ejection amount maximum value and
when the processing setting is a second setting meaning to not use the ejection amount reference value, the ejection amount upper limit value determination method further comprises a second final determination step in which a colorimetry result that is the colorimetry result of at least a part of the plurality of patches and that is different from the reading result is acquired, a first provisional ejection amount upper limit value, which is a provisional value of the upper limit value from the viewpoint of the colorimetry result, is determined based on the colorimetry result, the reading result of at least a part of the plurality of patches is acquired, a second provisional ejection amount upper limit value, which is a provisional value of the upper limit value from the viewpoint of the reading result, is determined based on the reading result, and the upper limit value is determined based on at least one of the first provisional ejection amount upper limit value and the second provisional ejection amount upper limit value.

6. The ejection amount upper limit value determination method according to claim 1, wherein
in the temporary determination step, when a difference value obtained by subtracting the ejection amount minimum value from the ejection amount maximum value is larger than a predetermined value, the provisional ejection amount upper limit value is determined based on the reading result,
in the first final determination step, when the difference value is larger than the predetermined value, the upper limit value is determined so as to be equal to or larger than the ejection amount minimum value and equal to or smaller than the ejection amount maximum value based on the ejection amount minimum value, the ejection amount maximum value, and the provisional ejection amount upper limit value, and
the ejection amount upper limit value determination method further comprises a third final determine step in which, when the difference value is equal to or smaller than the predetermined value, the upper limit value is determined so as to be equal to or larger than the ejection amount minimum value and equal to or smaller than the ejection amount maximum value based on at least one of the ejection amount reference value, the ejection amount minimum value, and the ejection amount maximum value.

7. A printing device comprising:
a print head configured to eject liquid onto the medium;
a control section configured to perform control to form a test pattern including a plurality of patches having different ejection amounts per unit area with respect to the liquid on the medium and configured to perform a process of determining an upper limit value of the ejection amount; and
a reading section configured to read at least a part of the plurality of patches, wherein
the control section performs
a first process for acquiring an ejection amount reference value, which is a reference of an allowable range of the upper limit value, and, based on the ejection amount reference value, determining an ejection amount minimum value, which is a minimum value of the allowable range and an ejection amount maximum value, which is a maximum value of the allowable range,
a second process for obtaining a reading result of at least a part of the plurality of patches from the reading section and, based on the reading result, determining a provisional ejection amount upper limit value, which is a provisional value of the upper limit value, and
a third process for determining the upper limit value so as to be equal to or larger than the ejection amount minimum value and equal to or smaller than the ejection amount maximum value based on the ejection amount minimum value, the ejection amount maximum value, and the provisional ejection amount upper limit value.
